(19) United States
(12) Patent Application Publication
(10) Pub. No.: US 2020/0101733 A1
(43) Pub. Date: Apr. 2, 2020

(54) HEAD UNIT AND LIQUID EJECTING APPARATUS

(71) Applicant: SEIKO EPSON CORPORATION, Tokyo (JP)

(72) Inventors: Hiroyuki HAGIWARA, Matsumoto-shi (JP); Katsuhiro OKUBO, Azumino-shi (JP); Takahiro KANEGAE, Shiojiri-Shi (JP); Hironori MATSUOKA, Alexandria, VA (US)

(21) Appl. No.: 16/584,175

(22) Filed: Sep. 26, 2019

(30) Foreign Application Priority Data
Sep. 28, 2018 (JP) 2018-183524

(51) Int. Cl. B41J 2/14

(52) U.S. Cl. CPC B41J 2/1433; B41J 2002/14419

(57) ABSTRACT

A head unit includes circulation heads disposed at different positions on an XY plane, supply pipes configured to supply liquid to the circulation heads, discharge pipes configured to discharge the liquid from the circulation heads to the outside, and flow path members connecting the circulation heads, the supply pipes, and the discharge pipes. Each circulation head includes a nozzle plate having nozzles. The nozzles include first nozzles on one end side in the X direction and second nozzles on the other end side in the X direction. During circulation, the liquid pressure in the first nozzles is higher than the liquid pressure in the second nozzles, and when the head unit is viewed from the Z direction in plan view, the first nozzles are disposed on both ends in the X direction or the second nozzles are disposed on both ends in the X direction.

The present application is based on, and claims priority from JP Application Serial Number 2018-183524, filed Sep. 28, 2018, the disclosure of which is hereby incorporated by reference herein in its entirety.

### BACKGROUND

### 1. Technical Field

The present disclosure relates to a head unit and a liquid ejecting apparatus having a plurality of circulation heads for ejecting liquid from nozzles. In particular, the present disclosure relates to a head unit and an ink jet recording apparatus for discharging ink as liquid.

### 2. Related Art

Liquid ejecting apparatuses such as ink jet recording apparatuses, for example, jet printers and plotters are provided with a liquid ejecting head capable of ejecting liquid, such as ink stored in a cartridge or a tank, as liquid droplets.

The liquid ejecting head used in such a liquid ejecting apparatus may be increased in length (many nozzles may be formed) or density, however, this may result in a larger liquid ejecting head, a decreased yield, and cost increase. Accordingly, it is difficult to increase the length or density of a single nozzle. To solve the problem, a head unit having a plurality of liquid ejecting heads fixed to a common fixing member as a unit is proposed.

Some example liquid ejecting heads includes a circulation head configured to allow ink to circulate through the liquid ejecting head in order to discharge bubbles in the ink, suppress the thickening of the ink, or suppress the sedimentation of the components in the ink (for example, see JP-A-2012-176560).

In arranging such circulation heads, the supply ports or the discharge ports may be disposed on the joint sides of the adjacent circulation heads in order to reduce a difference in weight of the ink discharged from the nozzles of the adjacent circulation heads (for example, see JP-A-2012-176560).

Between the head units having the circulation heads disposed in such an arrangement, however, still there is a difference in weight of the ink discharged from the nozzles of the adjacent circulation head units, resulting in uneven ink application due to the difference in density in the joint of the adjacent head units.

Such a problem may similarly occur not only in the head units for discharging ink but also in head units for discharging liquid other than ink.

### SUMMARY

An advantage of some aspects of the present disclosure is that a head unit and a liquid ejecting apparatus having a plurality of the head units disposed to reduce a difference in weight of discharged liquid between the adjacent head units to reduce uneven ink application are provided.

According to an aspect of the present disclosure for solving the above-described problems, a head unit includes, when three directions orthogonal to each other are an X direction, a Y direction, and a Z direction, a plurality of circulation heads disposed at different positions on an XY plane defined by the X direction and the Y direction, supply pipes configured to supply externally supplied liquid to the circulation heads, discharge pipes configured to discharge the liquid from the circulation heads to the outside, and flow path members having flow paths connecting the circulation heads, the supply pipes, and the discharge pipes. Each circulation head includes a nozzle plate having a plurality of nozzles, when the circulation head is viewed from the Z direction in plan view, the nozzles in the circulation head include first nozzles on one end side in the X direction and second nozzles on the other end side in the X direction, and during circulation, the liquid pressure in the first nozzles is higher than the liquid pressure in the second nozzles, and when the head unit is viewed from the Z direction in plan view, the first nozzles are disposed on both ends in the X direction or the second nozzles are disposed on both ends in the X direction.

According to another aspect of the present disclosure, a head unit includes, when three directions orthogonal to each other are an X direction, a Y direction, and a Z direction, a plurality of circulation heads disposed at different positions on an XY plane defined by the X direction and the Y direction, supply pipes configured to supply externally supplied liquid to the circulation heads, discharge pipes configured to discharge the liquid from the circulation heads to the outside, and flow path members having flow paths connecting the circulation heads, the supply pipes, and the discharge pipes. Each circulation head has a plurality of nozzles configured to eject the liquid and a manifold with which the nozzles commonly communicate, when the circulation heads are viewed from the Z direction in plan view, each circulation head has a supply port configured to supply the liquid to the manifold on one end side in the X direction and a discharge port configured to discharge the liquid in the manifold on the other end side in the X direction, and when the head unit is viewed from the Z direction in plan view, the supply ports are disposed at both ends in the X direction or the discharge ports are disposed at both ends in the X direction.

According to still another aspect of the present disclosure, a liquid ejecting apparatus includes the head units according to the above-described aspect.

### BRIEF DESCRIPTION OF THE DRAWINGS

FIG. 1 is a plan view illustrating a schematic structure of a liquid ejecting apparatus.

FIG. 2 is an exploded perspective view illustrating a head module.

FIG. 3 is a plan view illustrating a head module.

FIG. 4 is a perspective view of a head unit.

FIG. 5 is an exploded perspective view illustrating an upper side (−Z side) of a head unit.

FIG. 6 is an exploded perspective view illustrating a lower side (+Z side) of a head unit.

FIG. 7 is a plan view illustrating an ejection surface of a head unit.

FIG. 8 is a plan view illustrating circulation heads in a head unit viewed from the −Z side.

FIG. 9 is a graph illustrating the ink weight of a head module.

FIG. 10 is a plan view illustrating a modification of the head unit viewed from the −Z direction.

FIG. 11 is a cross-sectional view illustrating a circulation head.

FIG. 12 is a schematic view illustrating a flow path structure of a circulation head.

FIG. 13 is a schematic view illustrating flow paths.

FIG. 14 is a plan view illustrating a flow path member of a head unit.

FIG. 15 is a cross-sectional view of a flow path member.

FIG. 16 is a cross-sectional view of a flow path member.

FIG. 17 is a cross-sectional view of a flow path member.

FIG. 18 is a schematic view illustrating a flow path structure of a flow path member.

FIG. 19 is a plan view illustrating a modification of the head unit viewed from the −Z direction.

FIG. 20 is a plan view illustrating circulation heads in a head unit viewed from the −Z direction.

FIG. 21 is a plan view illustrating a flow path member in a head unit.

### DESCRIPTION OF EXEMPLARY EMBODIMENTS

Hereinafter, embodiments of the present disclosure will be described in detail. The following description merely describes an embodiment of the present disclosure, and may be changed in any way within the scope of the present disclosure. In the drawings, the same reference numerals are used to refer to the same or similar components, and the description thereof is omitted as appropriate. In the drawings, X, Y, Z show three spatial axes orthogonal to one another. In this specification, directions along these axes are defined as an X direction, a Y direction, and a Z direction, respectively, and in each drawing, the direction toward which the arrow is pointing is defined as a positive (+) direction and the opposite direction toward which the arrow is pointing is defines as a negative (−) direction. The Z direction indicates the vertical direction, the +Z direction indicates a vertically downward direction, and the −Z direction indicates a vertically upward direction.

### First Embodiment

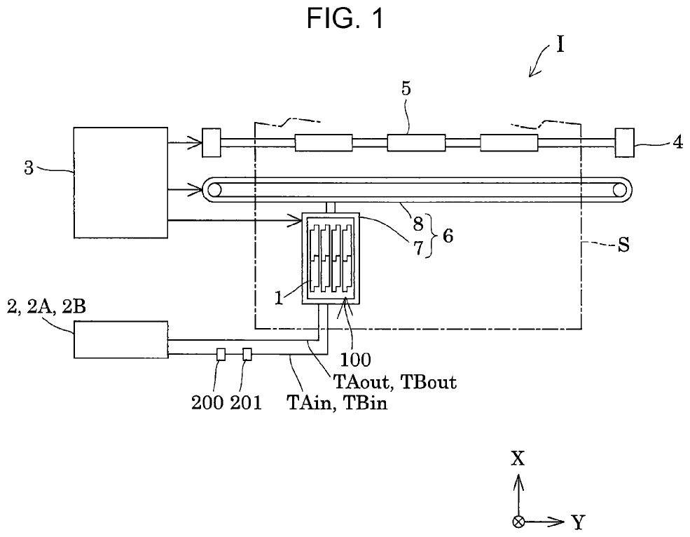

FIG. 1 is a plan view illustrating a schematic structure of a liquid ejecting apparatus I. As illustrated in FIG. 1, the liquid ejecting apparatus I according to the embodiment is an ink jet recording apparatus that ejects an ink that is a liquid to a medium S. Examples of the medium S to be used for the liquid ejecting apparatus I include paper, a plastic film, cloth, or the like.

To the liquid ejecting apparatus I, a liquid container 2 for storing ink is fixed. The liquid container 2 may be a cartridge that is detachably attached to the liquid ejecting apparatus I, a pouch-shaped ink pack formed of a flexible film, or an ink tank that can be refilled with ink. Although not particularly illustrated, the liquid container 2 stores a plurality of inks of different colors or types. The liquid container 2 is an example liquid storage section.

The liquid ejecting apparatus I includes a control unit 3 that is a controller, a transport mechanism 4, and a head module 100.

The control unit 3 includes, although not particularly illustrated, for example, a control device such as a central processing unit (CPU) or a field-programmable gate array (FPGA), and a storage device such as a semiconductor memory. The control unit 3 executes a program stored in the storage device to perform overall control of the components in the liquid ejecting apparatus I.

The transport mechanism 4 is controlled by the control unit 3 to transport the medium S in the X direction, and includes, for example, a transport roller 5. The transport mechanism for transporting the medium S is not limited to the transport roller 5, and may be a belt or a drum for transporting the medium S.

A moving mechanism 6 is controlled by the control unit 3 to reciprocate the head module 100 in the Y direction. The Y direction in which the head module 100 is reciprocated by the moving mechanism 6 intersects with the X direction in which the medium S is transported.

Specifically, the moving mechanism 6 according to the embodiment includes a transport member 7 and a transport belt 8. The transport member 7 is a substantially box-shaped structure for supporting the head module 100, a so-called carriage, and is fixed to the transport belt 8. The transport belt 8 is an endless belt that is installed along the Y direction. The transport belt 8 is rotated under the control of the control unit 3 such that the head module 100 reciprocates together with the transport member 7 along the Y direction. The liquid container 2 may be disposed in the transport member 7 together with the head module 100.

In this embodiment, eight liquid containers 2 are provided (FIG. 1 collectively illustrates one liquid container 2), and to one head unit 1, an ink is supplied from two liquid containers 2. The two liquid containers 2 that correspond to one head unit 1 are referred to as a liquid container 2A and a liquid container 2B respectively. To the liquid container 2A, a supply tube TAin and a discharge tube TAout are connected. To the liquid container 2B, a supply tube TBin and a discharge tube TBout are connected. The supply tube TAin, the discharge tube TAout, the supply tube TBin, and the discharge tube TBout may be collectively referred to as a tube.

The supply tube TAin and the supply tube TBin are used to supply the inks in the liquid container 2A and the liquid container 2B, which are controlled to a predetermined pressure by a pump 200 and to a predetermined temperature by a heater 201, to the head module 100. The discharge tube TAout and the discharge tube TBout are used to discharge the ink discharged from the head module 100 to the liquid container 2A and the liquid container 2B.

Such liquid container 2A and liquid container 2B, and the tube are provided for each head unit 1.

The head module 100 ejects the ink supplied from the liquid container 2 to the medium S as ink droplets, which are liquid droplets, under the control of the control unit 3. The ejection of the ink droplets from the head module 100 is performed toward the positive side in the Z direction. While the medium S is transported in the X direction by the transport mechanism 4 and the head module 100 is transported in the Y direction by the moving mechanism 6, the head module 100 ejects ink droplets onto the medium S to form a desired image on the medium S.

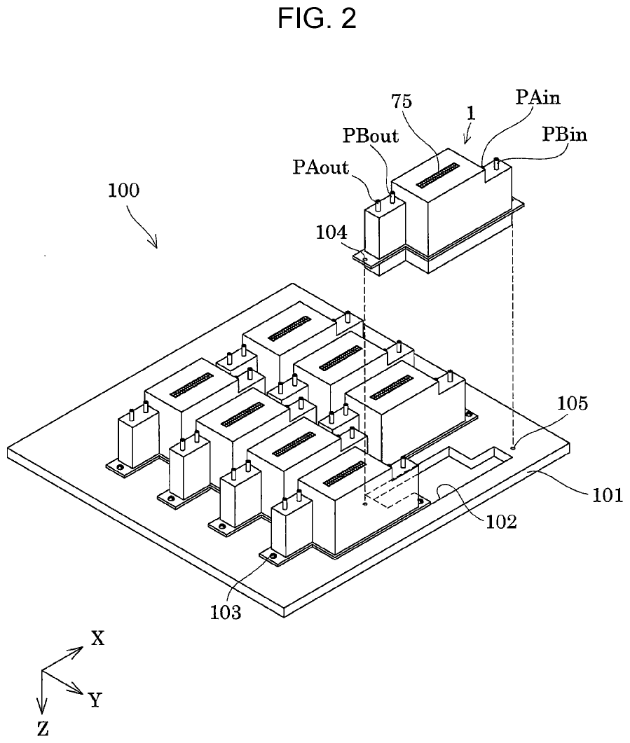

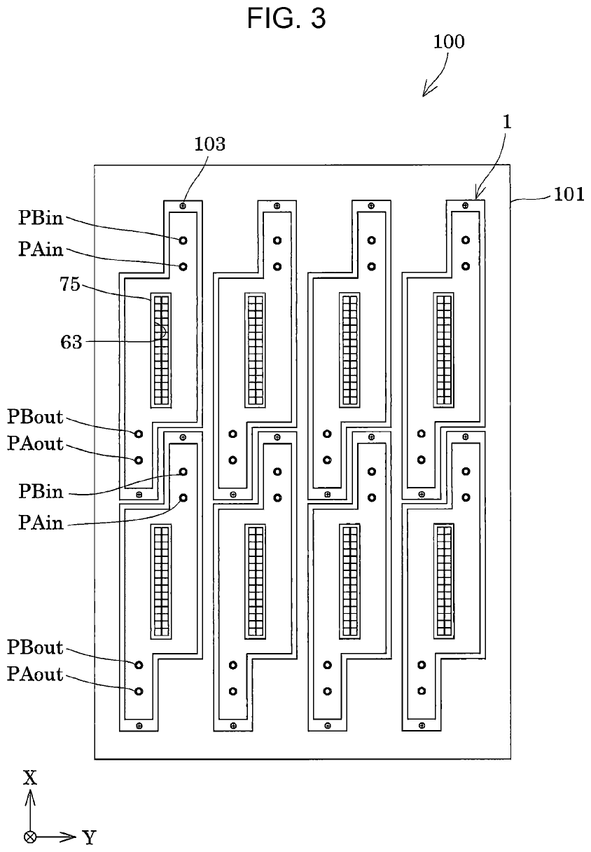

The head module 100 will be described in detail with reference to FIG. 2 and FIG. 3. FIG. 2 is an exploded perspective view illustrating the head module according to the embodiment. FIG. 3 is a plan view illustrating the head module.

The head module 100 includes a supporting member 101 and a plurality of head units 1. The supporting member 101 is a plate-like member for supporting the head units 1. The supporting member 101 has support holes 102 for supporting the head unit 1. The support hole 102 according to the embodiment is independently provided for each head unit 1. The support hole 102 may be provided continuously for the plurality of head units 1.

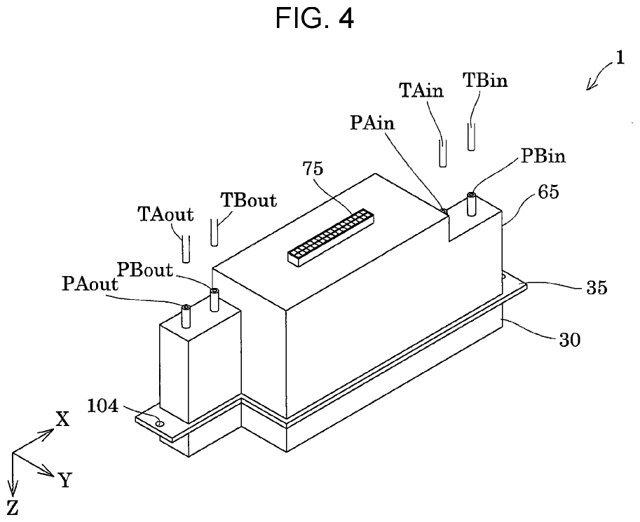

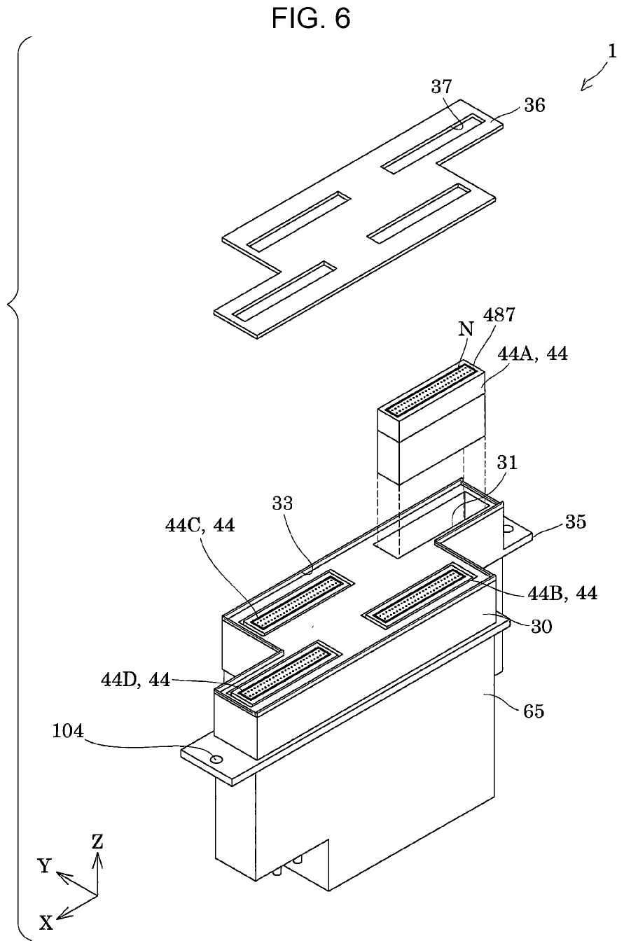

The head unit 1 is inserted into the support hole 102 and a flange section 35 (see FIG. 4), which will be described below, of the head unit 1 is supported by a peripheral edge portion of the support hole 102. A circulation head 44 (see FIG. 6) side of the head unit 1 protrudes from a +Z side of the supporting member 101.

Each head unit 1 has fixing holes 104 at both end portions in the X direction. The supporting member 101 has screw holes 105 for fixing the head unit 1. Each head unit 1 is fixed to the supporting member 101 with screws 103 inserted through the fixing holes 104 and screwed into the screw holes 105.

In this embodiment, two head units 1 are fixed in the X direction, and four head units 1 are fixed in the Y direction, that is, a total of eight head units are fixed to the supporting member 101. Each head unit 1 is disposed such that nozzles N, which will be described below, are disposed side by side in the X direction.

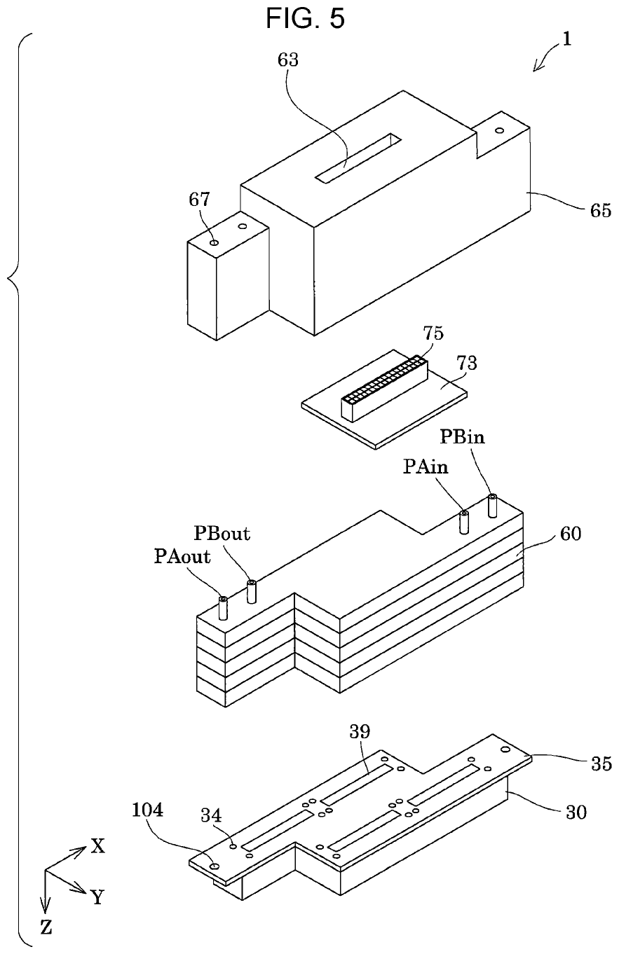

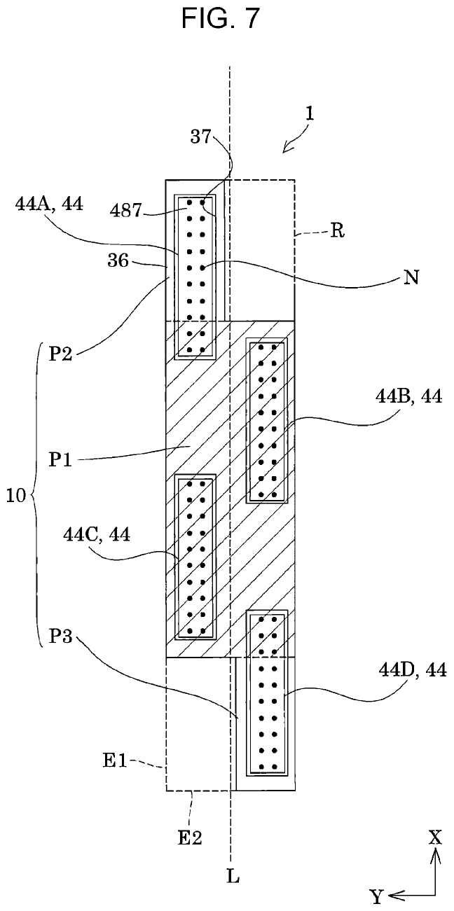

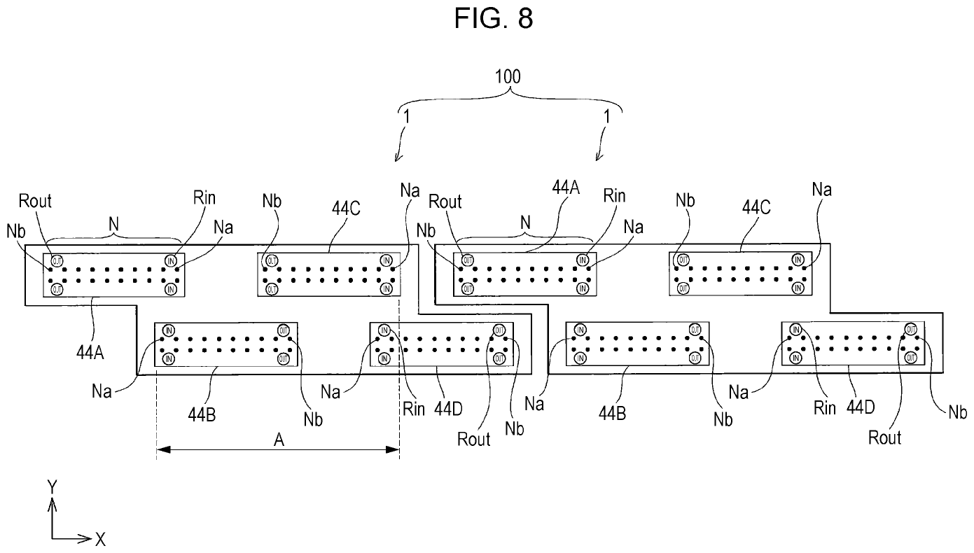

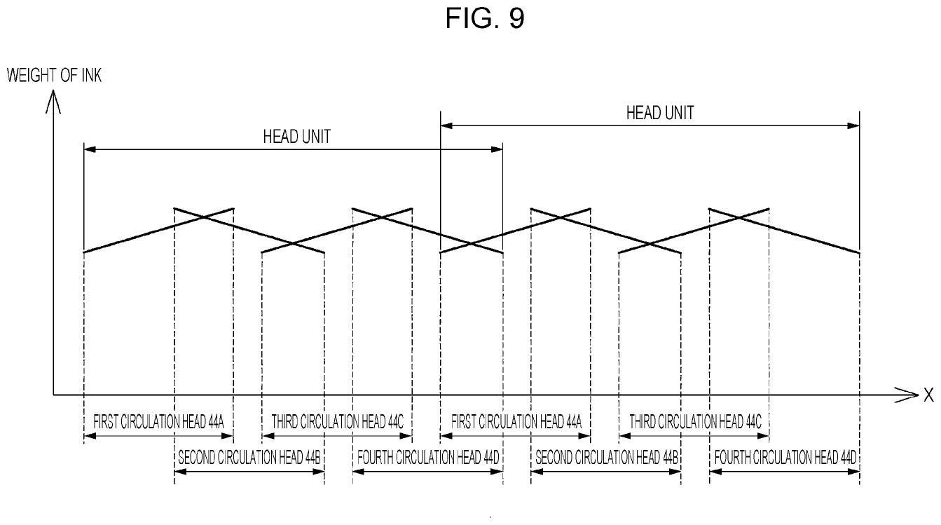

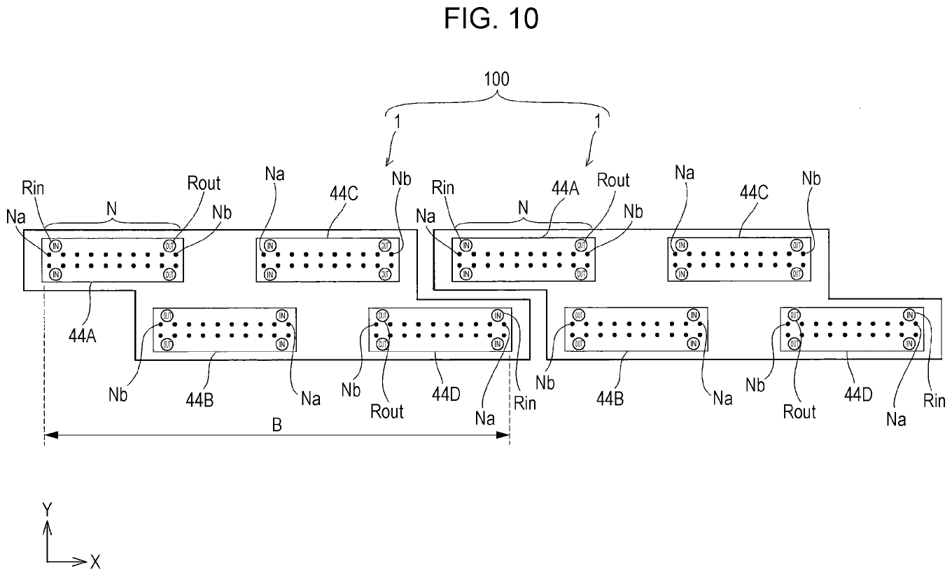

Hereinafter, the head unit 1 will be described in detail with reference to FIGS. 4 to 9. FIG. 4 is a perspective view of the head unit. FIG. 5 is an exploded perspective view illustrating an upper side (−Z side) of the head unit. FIG. 6 is an exploded perspective view illustrating a lower side (+Z side) of the head unit. FIG. 7 is a plan view illustrating an ejection surface of the head unit. FIG. 8 is a plan view illustrating the circulation heads in the head unit viewed from the −Z side. FIG. 9 is a graph illustrating the weight of ink droplets discharged from the head units. FIG. 10 illustrates a modification of the head unit. Note that part of the head unit is not illustrated in FIG. 8.

As illustrated in FIG. 5 to FIG. 8, the head unit 1 has a plurality of circulation heads 44, a holder 30 for holding the circulation heads 44, flow path member 60 for supplying ink to the circulation heads 44, and a connector 75 to which a wire for sending or receiving a control signal or the like is connected. In this embodiment, one head unit 1 has four circulation heads 44.

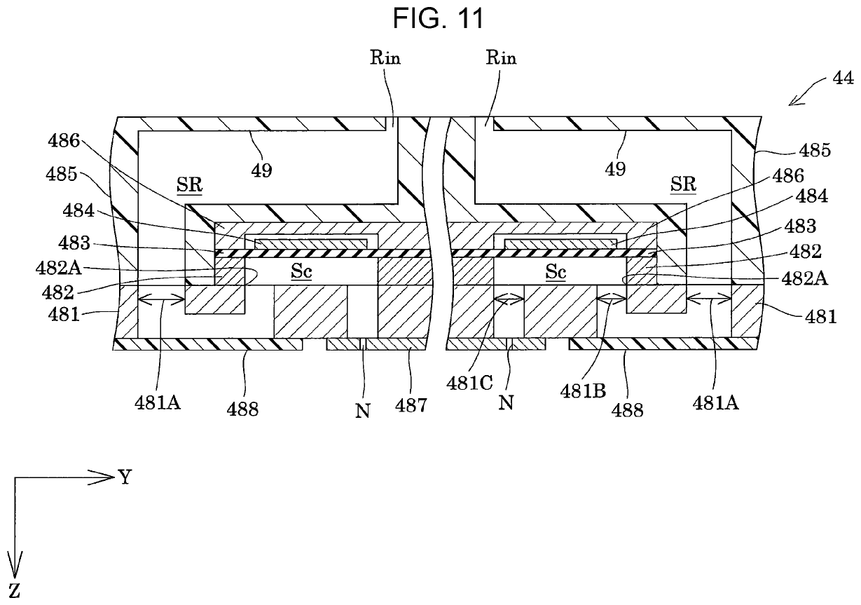

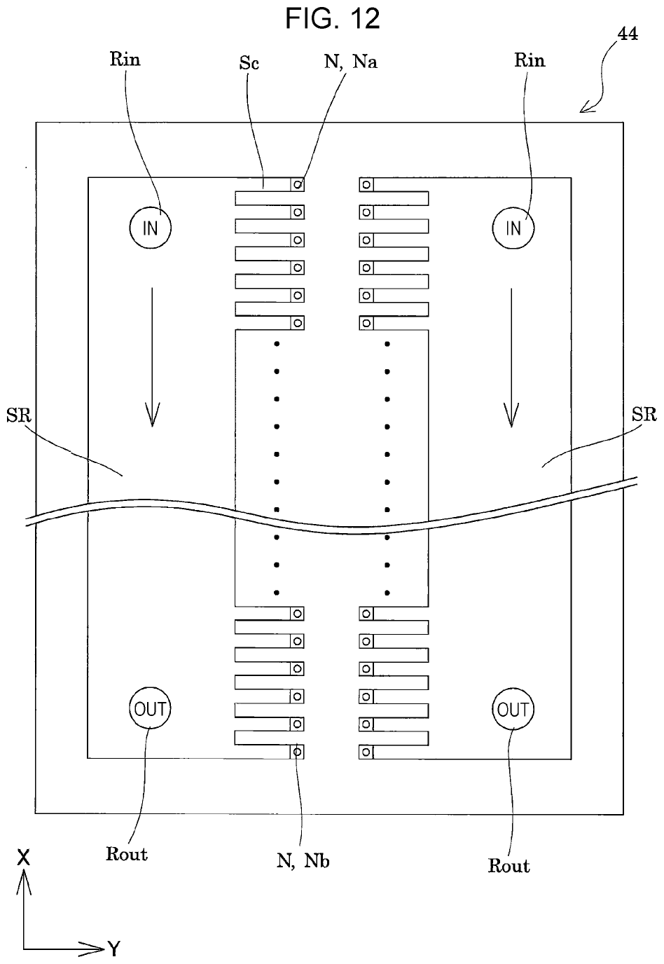

The circulation head 44 according to the embodiment will be further described with reference to FIG. 11 and FIG. 12. FIG. 11 is a cross-sectional view illustrating the circulation head. FIG. 12 is a schematic view illustrating a flow path structure of the circulation head. As illustrated in FIG. 11 and FIG. 12, the circulation head 44 according to the embodiment is a structure having a pressure chamber plate 482, a diaphragm 483, piezoelectric actuators 484, a housing section 485, and a protection plate 486 disposed on one side of a flow-path formed plate 481, and a nozzle plate 487 and a buffer plate 488 disposed on the other side of the flow-path formed plate 481.

The flow-path formed plate 481, the pressure chamber plate 482, and the nozzle plate 487 are, for example, silicon plates, and the housing section 485 is, for example, formed by injection molding using a resin material. The nozzles N are provided in the nozzle plate 487. A surface of the nozzle plate 487 opposite to the flow-path formed plate 481 is a nozzle surface.

The flow-path formed plate 481 has openings 481A, branch flow paths 481B that are throttle flow paths, and communication flow paths 481C. The branch flow path 481B and the communication flow path 481C are through holes provided for each nozzle N, and the opening 481A is a continuous opening provided through a plurality of nozzles N. The buffer plate 488 is a compliance plate formed of a flat plate, and disposed on a surface of the flow-path formed plate 481 opposite to the pressure chamber plate 482 to block the openings 481A. The buffer plate 488 flexibly deforms to absorb pressure fluctuations in the openings 481A.

The housing section 485 has manifolds SR that are common liquid chambers communicating with the openings 481A in the flow-path formed plate 481. The manifold SR is a space for storing an ink to be supplied to a plurality of nozzles N, and is provided continuously for the plurality of nozzles N. The housing section 485 has, as illustrated in FIG. 11, supply ports Rin through which ink is supplied from an upstream side into the manifolds SR and discharge ports Rout through which the ink is discharged from the manifolds SR toward a downstream side. In FIG. 8, the supply port Rin is indicated by “IN” and the discharge port Rout is indicated by “OUT”. The supply port Rin, as will be described in detail below, is connected to supply pipes PAin and PBin of the flow path member 60 through supply paths 61A and 61B, and the discharge port Rout is connected to discharge pipes PAout and PBout of the flow path member 60 through discharge paths 62A and 62B.

As illustrated in FIG. 8 and FIG. 11, in this embodiment, the circulation head 44 has nozzles N disposed side by side along the X direction. The circulation head 44 has, in the Y direction, a plurality of arrays of the nozzles N disposed side by side along the X direction, in this embodiment, two arrays. Specifically, one circulation head 44 has two circulation flow paths for ink to circulate from the supply ports Rin, through the manifolds SR that are connected to respective arrays of nozzles N, toward the discharge ports Rout.

Such a supply port Rin is disposed on one end side of the manifold SR in the X direction, which is the direction of the arrays of the nozzles N, and the discharge port Rout is disposed on the other end side of the manifold SR in the X direction. The ink supplied from the supply port Rin into the manifold SR is discharged to the outside of the manifold SR from the discharge port Rout. In other words, the ink circulates through the manifold SR.

Since the ink in the manifold SR is circulating and a pressure is exerted on the manifold SR, the pressure in the manifold SR affects the pressure in a pressure chamber SC as a back pressure when the ink is discharged from the nozzles N. Furthermore, in the manifold SR, the supply port Rin provided at one end portion in the X direction and the discharge port Rout provided at the other end portion cause a pressure gradient from a pressure chamber SC on the supply port Rin side, which is an upstream side, toward a pressure chamber SC on the discharge port Rout side, which is a downstream side. Accordingly, larger pressure fluctuations occur in the pressure chamber SC on the supply port Rin side, which is the upstream side, than in the pressure chamber SC on the discharge port Rout side, which is the downstream side. Similar pressure fluctuations occur in nozzles N communicating with the pressure chambers SC. Such pressure fluctuations affect the amount of ink discharge, that is, the weight of ink gradually decreases from the supply port Rin side, the upstream side, toward the discharge port Rout side, downstream side.

Specifically, while the ink is circulating through the manifold SR, in the nozzles N communicating with the manifold SR, the pressure of the ink in the nozzle N at one end portion on the supply port Rin side is higher than the pressure of the ink in the nozzle N at the other end portion on the discharge port Rout side. In this embodiment, in the X direction along which the nozzles N are disposed side by side, the nozzle N at one end portion on the supply port Rin side is referred to as a first nozzle Na and the nozzle N at the other end portion on the discharge port Rout side is referred to as a second nozzle Nb. Consequently, at the time of circulation, the pressure of the ink in the first nozzle Na is higher than the pressure of the ink in the second nozzle Nb. Accordingly, the weight of ink droplets discharged from the first nozzle Na is greater than the weight of ink droplets discharged from the second nozzle Nb.

The pressure chamber plate 482 has an opening 482A that is provided in each nozzle N. The diaphragm 483 is an elastic deformable plate provided on the surface of the pressure chamber substrate 482 opposite to the flow-path formed plate 481. A space defined by the diaphragm 483 and the flow-path formed plate 481 in each opening 482A of the pressure chamber plate 482 serves as a pressure chamber SC into which the ink supplied from the manifold SR through the branch flow path 481B is filled. Each pressure chamber SC communicates with the nozzle N through the communication flow path 481C of the flow-path formed plate 481.

The piezoelectric actuator 484 is provided on the surface of the diaphragm 483 opposite to the pressure chamber substrate 482 for each nozzle N. The piezoelectric actuator 484 may be referred to as a piezoelectric element, and is a drive element that has electrodes that face each other having a piezoelectric member therebetween. The piezoelectric actuator 484 deforms in accordance with a drive signal to vibrate the diaphragm 483, and this vibration changes the pressure in the ink in the pressure chamber SC to cause the ink in the pressure chamber SC to be ejected from the nozzle N. The protection plate 486 protects a plurality of piezoelectric actuators 484.

It is to be understood that instead of the piezoelectric actuators 484, heating elements may be disposed in the flow path to generate heat to produce bubbles, and ink droplets may be discharged from the nozzles N by using the bubbles, or so-called electrostatic actuators for generating static electricity between the diaphragm 483 and an electrode and deforming the discharge port 483 by the static electricity to discharge ink droplets from the nozzles N may be used.

As illustrated in FIG. 5 to FIG. 8, a plurality of circulation heads 44 are provided for one head unit 1, in this embodiment, four circulation heads 44 are provided. Specifically, the circulation heads 44 are held by the common holder 30 in the head unit 1.

The holder 30 has a recessed portion 33 that opens on a surface on the +Z side, and on a bottom of the recessed portion 33, recessed accommodating sections 31 are provided as illustrated in FIG. 5 and FIG. 6. The recessed portion 33 has an opening of a size and shape that allow a fixing plate 36 to be fitted into the recessed portion 33. The accommodating section 31 has an opening of a size and shape to accommodate the circulation head 44.

The holder 30 has the flange section 35 on a surface on the −Z side. The above-described fixing holes 104 are provided at both end portions of the flange section 35 in the X direction.

Each circulation head 44 is fixed to the fixing plate 36. Specifically, the fixing plate 36 has a shape to be accommodated in the recessed portion 33, and has exposure openings 37 at predetermined positions. Each circulation head 44 is fixed to the fixing plate 36 with an adhesive or the like such that the buffer plate 488 is covered by the fixing plate 36 and the nozzles N (nozzle plate 487) are exposed through the exposure openings 37. The circulation heads 44 fixed to the fixing plate 36 in this manner are accommodated in the accommodating sections 31 such that the nozzle plate 487 side is on the +Z side. The fixing plate 36 is fixed to the recessed portion 33 with an adhesive or the like. A surface of the circulation head 44 on the −Z side is bonded to the bottom of the accommodating section 31 with an adhesive.

In this structure, the circulation heads 44 are accommodated in the space defined by the accommodating sections 31 and the fixing plate 36, and the nozzles N are exposed through the exposure openings 37. Note that the accommodating sections 31 may be provided as a common accommodating section 31 for the plurality of the circulation heads 44.

As illustrated in FIG. 7, the circulation heads 44 held by the holder 30 are disposed such that the positions in an XY plane defined by the X direction and the Y direction are different with each other. Specifically, when viewed from the Z direction in plan view, the circulation heads 44 are disposed so as not to overlap each other. The expression “the circulation heads 44 are disposed such that the positions in the XY plane are different with each other” means that the nozzle surfaces of the circulation heads 44 are disposed at positions different with each other. Accordingly, portions other than the nozzle surfaces of the circulation heads may overlap each other in the Z direction.

The circulation heads 44 are arranged, as described above, such that the first nozzles Na are disposed on one end side in the X direction and the second nozzles Nb are disposed on the other end side in the X direction. In this embodiment, the nozzles are disposed side by side along the X direction to form the nozzle arrays.

Furthermore, in this embodiment, the circulation heads 44 are disposed in a staggered arrangement along the X direction. In the arrangement in which the circulation heads 44 are disposed in a staggered manner along the X direction, the circulation heads 44 disposed side by side in the X direction are alternately shifted in the Y direction. Specifically, the circulation heads 44 disposed side by side in the X direction form two arrays of the circulation heads 44 in the Y direction and the two arrays of the circulation heads 44 are shifted by a half pitch in the X direction. In such an arrangement of the circulation heads 44 staggered in the X direction, some of the nozzles N in the two circulation heads 44 are overlapped in the X direction, and thus the array of the nozzles N continuous in the X direction is provided.

Hereinafter, with reference to FIG. 7, an ejection surface 10 of the head unit 1 will be described. An ejection surface is a surface of the head unit 1 in which the nozzles N are open and faces a medium S. In this embodiment, the surface of the fixing plate 36 on the +Z side and the nozzle surfaces of the nozzle plates 487 that are exposed through the exposure openings 37 form the ejection surface 10.

A rectangle of a smallest area including the ejection surface 10 is defined as rectangle R. Then, in this embodiment, a long side E1 of the rectangle R overlaps a side of the holder 30 along the X direction and a short side E2 of the rectangle R overlaps a side of the holder 30 along the Y direction. A center line parallel to the long side E1 of the virtual rectangle R is defined as L.

A planar shape of the ejection surface 10 includes a first portion P1 (hatched portion in FIG. 7) through which the center line L passes, and a second portion P2 and a third portion P3 through which the center line L does not pass. The third portion P3 is on the opposite side to the second portion P2 across the first portion P1. In this embodiment, the first portion P1, the second portion P2, and the third portion P3 are rectangles.

In the first portion P1, the second portion P2, and the third portion P3, the nozzle surfaces of the circulation heads 44 are arranged in the staggered manner. As illustrated in FIG. 8, in the head module 100 including the head units 1 disposed side by side in the X direction, the second portion P2 in one head unit 1 and the third portion P3 in the other head unit 1 face in the Y direction. With this structure, some nozzles N in the head units 1 adjacent in the X direction overlap in the X direction and thereby the array of nozzles N continuous in the X direction can be formed. The second portion P2 and the third portion P3 in the head units disposed side by side in the X direction provide the compact head that is reduced in length in the Y direction.

In the head unit 1, as illustrated in FIG. 8, the circulation heads 44 are disposed such that the second nozzles Nb are arranged at both end portions of the head unit 1 in the X direction when viewed from the Z direction in plan view. Specifically, in order from the −X side toward the +X direction, if the circulation heads 44 disposed side by side in the X direction are referred to as a first circulation head 44A, a second circulation head 44B, a third circulation head 44C, and a fourth circulation head 44D, the second nozzle Nb is disposed on the −X side of the first circulation head 44A, and the second nozzle Nb is disposed on the +X side of the fourth circulation head 44D. The nozzles N at both end portions of the head unit 1 in the X direction are, among all nozzles N in the circulation heads 44, the nozzle N at the end portion in the −X direction and the nozzle N at the end portion in the +X direction. The circulation heads 44 are disposed such that the nozzles N at both end portions are the second nozzles Nb.

In other words, the supply port Rin for supplying ink into the manifold SR is disposed on one end side of the manifold SR in the X direction, which is the direction the nozzles N, are disposed side by side, and the discharge port Rout is disposed on the other end side of the manifold SR. In this embodiment, when the head unit is viewed from the Z direction in plan view, the circulation heads 44 are disposed such that the discharge ports Rout are disposed at both ends in the X direction.

Accordingly, as illustrated in FIG. 8, in the head module 100 including the head units 1 arranged in the X direction, between the two head units 1 adjacent in the X direction, the difference in pressure in the adjacent nozzles N is reduced and differences in weight of the ink discharged from the adjacent nozzles N can be reduced. As illustrated in FIG. 9, the weight of the ink discharged from the second nozzles Nb at both end portions of the head unit 1 is less than that from the first nozzles Na, and by arranging the head units 1 in the X direction such that the second nozzles Nb from which less ink is discharged are arranged on the same end portion sides, the difference in weight of ink droplets discharged from the nozzles N between the head units 1 can be reduced. Accordingly, rapid change in the density of ink discharged from the nozzles N between the two adjacent head units can be reduced and the uneven ink application, in particular, uneven streaks of ink due to the density change can be reduced. Furthermore, the head module 100 consisting of a plurality of head units 1 disposed side by side in the X direction has the second nozzles Nb as the nozzles N at both ends of each head unit 1, and this structure enables the simplified assembling process without specifying the orientation of the head units 1 in the X direction. With this structure, the head units 1 according to the embodiment achieve the reduced difference in the weight of the ink discharged from adjacent nozzles N between adjacent head units 1 regardless of whether the first circulation head 44A is disposed on the +X side or on the −X side in the X direction.

In this embodiment, as illustrated in FIG. 8, two circulation heads 44 adjacent in the X direction, that is, two circulation heads 44 disposed so as to overlap in the Y direction are arranged such that nozzles N of one circulation head 44 at the end portion on the side close to the other circulation head 44 are the nozzles N of the same type as the nozzles N of the other circulation head 44 at the end portion on the side close to the one circulation head 44. Specifically, among the two circulation heads adjacent in the X direction, when the nozzles N of one circulation head at the end portion on the side close to the other circulation head are the first nozzles Na, the nozzles N of the other circulation head at the end portion on the side close to the one circulation head are also the first nozzles Na. Similarly, among the two circulation heads adjacent in the X direction, when the nozzles N of one circulation head at the end portion on the side close to the other circulation head are the second nozzles Nb, the nozzles N of the other circulation head at the end portion on the side close to the one circulation head are also the second nozzles Nb.

In this embodiment, in the first circulation head 44A and the second circulation head 44B adjacent in the X direction, the nozzles N of the first circulation head 44A at the end portion on the +X side are the first nozzles Na, the nozzles N of the second circulation head 44B at the end portion on the −X side are the first nozzles Na.

Similarly, in the second circulation head 44B and the third circulation head 44C adjacent in the X direction, the nozzles N of the second circulation head 44B at the end portion on the +X side are the second nozzles Nb, the nozzles N of the third circulation head 44C at the end portion on the −X side are the second nozzles Nb.

Similarly, in the third circulation head 44C and the fourth circulation head 44D adjacent in the X direction, the nozzles N of the third circulation head 44C at the end portion on the +X side are the first nozzles Na, the nozzles N of the fourth circulation head 44D at the end portion on the −X side are the first nozzles Na.

With this structure, in the circulation heads 44 adjacent in the X direction, the nozzles N of the same type are disposed at the end portions in the overlapping portions in the Y direction, and thus the difference in pressure in the adjacent nozzles N in the circulation can be reduced in the two circulation heads 44 adjacent in the X direction. Accordingly, as illustrated in FIG. 9, between the two head units 44 adjacent in the X direction, differences in weight of the inks discharged from the adjacent nozzles N can be suppressed. Consequently, rapid change in the density of the ink discharged from the nozzles N between the two adjacent head units 44 can be suppressed and the visible color unevenness due to the density change can be suppressed.

Note that in the circulation heads 44 adjacent in the X direction, the number of the circulation heads 44 needs to be even so that the nozzles N of the same type are disposed at the end portions in the overlapping portions in the Y direction. When the circulation heads are viewed from the Z direction in plan view as described above, if the circulation heads 44 of an odd number are arranged, when the circulation heads 44 are disposed such that the second nozzles Nb are disposed at both end portions in the liquid ejection head unit in the X direction, it is not possible to achieve the arrangement for suppressing the ink weight difference between all two circulation heads 44 adjacent in the X direction. Consequently, when the circulation heads 44 are viewed from the Z direction in plan view, the number of the circulation heads 44 needs to be even in order to dispose the second nozzles Nb at both end portions of the head units 1 in the X direction and to dispose the nozzles N of the same type at the end portions in the overlapping portions in the Y direction in the circulation heads 44 adjacent in the X direction.

In this embodiment, when the circulation heads 44 are viewed from the Z direction in plan view, the second nozzles Nb are disposed at both end portions of the head units 1 in the X direction. However, the structure is not limited to this example, and as illustrated in FIG. 10, the circulation heads 44 may be disposed such that the first nozzles Na are disposed at both end portions of the head units 1 in the X direction when viewed from the Z direction in plan view.

However, as illustrated in FIG. 10, in the arrangement in which the first nozzles Na are disposed at both end portions of the head units 1 in the X direction, the supply ports Rin of the circulation heads 44 are separately disposed in a range indicated by an arrow B in the X direction.

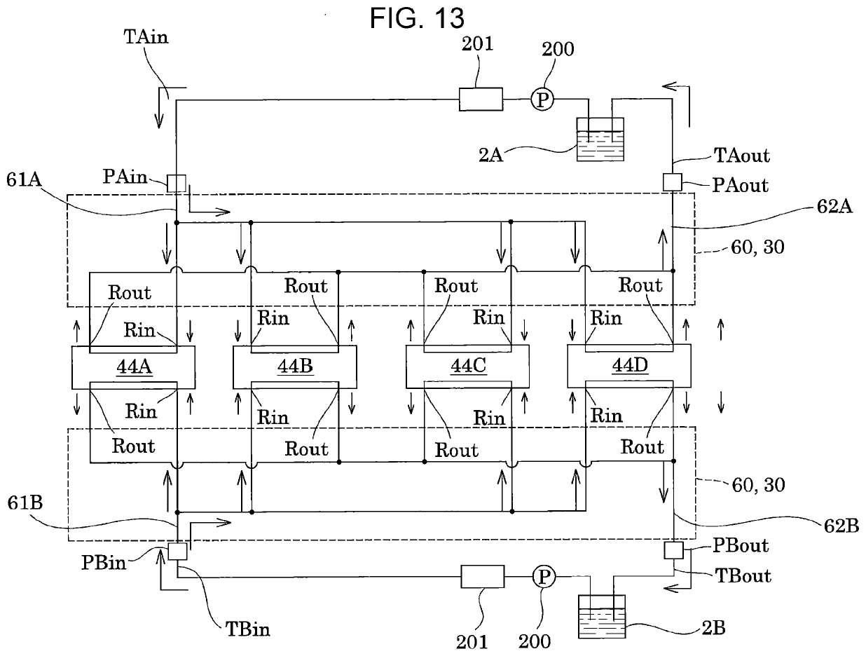

On the other hand, as illustrated in FIG. 8, in the arrangement in which the second nozzles Nb are disposed at both end portions of the head units 1 in the X direction, the supply ports Rin of the circulation heads 44 are concentrated in a range indicated by an arrow A, which is narrower than the range indicated by the arrow B, in the X direction. Accordingly, the arrangement in which the second nozzles Nb are disposed at both end portions of the head units 1 in the X direction provides the short supply paths 61A and 61B (see FIG. 13) in the flow path member 60 that are connected to the supply ports Rin in the relatively narrow range indicated by the arrow A. As a result, the occurrence of the variation in the flow path resistance can be reduced in the supply paths 61A and 61B connected to the supply ports Rin. The low variation in the flow path resistance in the supply paths 61A and 61B reduces the variation in the ejection characteristics of ink droplets discharged from the circulation heads 44 and reduces the difference in weight of ink droplets between the circulation heads 44. Accordingly, the occurrence of the uneven ink application due to the weight difference can be reduced between the adjacent circulation heads 44. Furthermore, the variations in the flow path resistance in the supply paths can be reduced and thus the variations in the flow path resistance in the supply paths can be reduced. Accordingly, it is not necessary to increase the flow path cross sections of the supply paths, and the increase in size of the flow path member 60 due to an increased supply path cross section can be prevented.

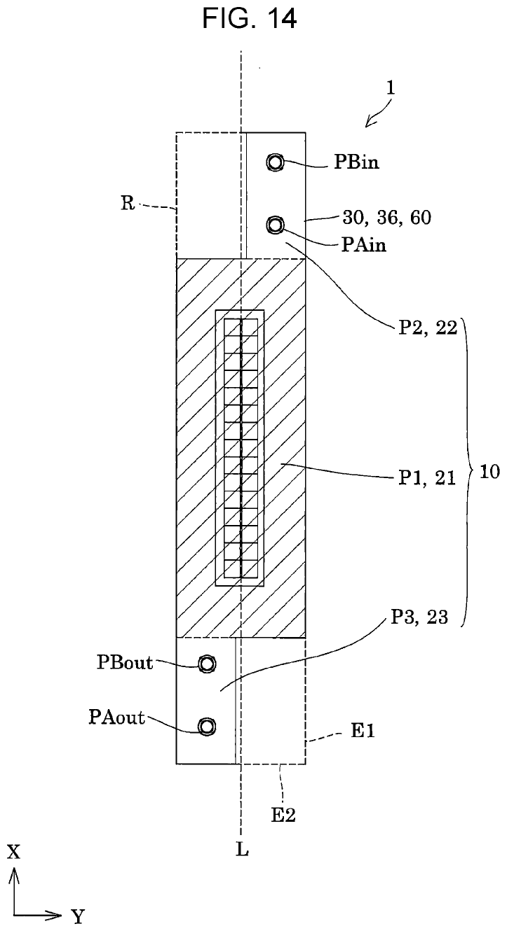

Hereinafter, the flow path member 60 will be further described with reference to FIG. 13 and FIG. 14. FIG. 13 is a schematic view illustrating flow paths. FIG. 14 is a plan view illustrating the flow path member of the head unit.

As illustrated in FIG. 5 and FIG. 13, the flow path member 60 has flow paths for supplying ink to the circulation heads 44. In this embodiment, the supply path 61A and the supply path 61B for supplying ink to the circulation heads 44, and the discharge path 62A and the discharge path 62B for discharging the ink from the circulation heads 44 are provided. As described above, the circulation heads 44 according to the embodiment has two manifolds SR and the supply ports Rin and the discharge ports Rout for respective manifolds SR. With this structure, two types of ink are supplied and discharged for circulation through the circulation heads 44. For the circulation, the flow path member 60 has the supply path 61A and the supply path 61B that communicate with the two supply ports Rin of the circulation heads 44 respectively, and the discharge path 62A and the discharge path 62B that communicate with the two discharge ports Rout respectively.

The flow path member 60 has, on a −Z side surface, a supply pipe PAin, a supply pipe PBin, a discharge pipe PAout, and a discharge pipe PBout, which are cylindrical pipes protruding toward the −Z side. As illustrated in FIG. 13, the supply pipe PAin communicates with the supply path 61A, and the supply pipe PBin communicates with the supply path 61B. The discharge pipe PAout communicates with the discharge path 62A, and the discharge pipe PBout communicates with the discharge path 62B.

To each of the supply pipes PAin and PBin and the discharge pipes PAout and PBout, a tube is detachably attached. To the supply pipe PAin, a supply tube TAin is connected, and to the supply pipe PBin, a supply tube TBin is connected. To the discharge pipe PAout, a discharge tube TAout is connected, and to the discharge pipe PBout, a discharge tube TBout is connected.

The supply path 61A is branched into four paths in the flow path member 60 as will be described in detail below. Each branched flow path communicates with a communication path 34 (see FIG. 5) in the holder 30. Similarly, the supply path 61B is branched into four paths in the flow path member 60. Each branched flow path communicates with the communication path 34 (see FIG. 5) in the holder 30.

The discharge path 62A is branched into four paths in the flow path member 60. Each branched flow path communicates with the communication path 34 (see FIG. 5) in the holder 30. Similarly, the discharge path 62B is branched into four paths in the flow path member 60. Each branched flow path communicates with the communication path 34 (see FIG. 5) in the holder 30.

Four communication paths 34 are provided for one circulation head 44. Each communication path 34 communicates with the two supply ports Rin and the discharge ports Rout.

The ink in the liquid container 2A is pressurized to a predetermined pressure by the pump 200, heated to a predetermined temperature by the heater 201, and supplied to the supply path 61A via the supply tube TAin and the supply pipe PAin. The ink is branched in the supply path 61A and supplied to one supply port Rin of the four circulation heads 44 via the communication path 34. The ink discharged from the discharge ports Rout of the four circulation heads 44 merges in the discharge path 62A via the communication path 34, and is returned to the liquid container 2A via the discharge pipe PAout and the discharge tube TAout. The liquid container 2A, the supply tube TAin, the supply pipe PAin, the discharge tube PAout, and the discharge tube TAout are designed so as to maintain the pressure in the individual nozzles N in the circulation heads 44A, 44B, 44C, and 44D to a negative pressure within a predetermined range. The supply ports Rin and the discharge ports Rout may be maintained at a negative pressure within a predetermined range. The pressure may be maintained by generating a constant negative pressure by lowering the liquid head of the liquid container 2A with respect to the circulation heads 44, or by maintaining the pressure in the liquid container 2A at a constant negative pressure. A check valve may be disposed between the pump 200 and the liquid container 2A as necessary.

The ink in the liquid container 2B is pressurized to a predetermined pressure by the pump 200, heated to a predetermined temperature by the heater 201, and supplied to the supply path 61B via the supply tube TBin and the supply pipe PBin. The ink is branched in the supply path 61B and supplied to the other supply ports Rin of the four circulation heads 44 via the communication path 34. The ink discharged from the discharge ports Rout of the four circulation heads 44 merges in the discharge path 62B via the communication path 34, and is returned to the liquid container 2B via the discharge pipe PBout and the discharge tube TBout. The liquid container 2B, the supply tube TBin, the supply pipe PBin, the discharge tube PBout, and the discharge tube TBout are designed so as to maintain the pressure in the individual nozzles N in the circulation heads 44A, 44B, 44C, and 44D to a negative pressure within a predetermined range, similarly to the liquid container 2A. The supply ports Rin and the discharge ports Rout may be maintained at a negative pressure within a predetermined range. The pressure may be maintained by generating a constant negative pressure by lowering the liquid head of the liquid container 2B with respect to the circulation heads 44, or by maintaining the pressure in the liquid container 2B at a constant negative pressure. A check valve may be disposed between the pump 200 and the liquid container 2B as necessary.

As described above, the holder 30 has the communication path 34 through which the ink passes, and thus the holder 30 also serves as a flow path member.

Such flow path member 60 is accommodated in a cover member 65 that is fixed to a −Z side of the holder 30, as illustrated in FIG. 5.

The cover member 65 has four through holes 67 on the −Z side surface, and through these four through holes 67, the supply pipe PAin, the supply pipe PBin, the discharge pipe PAout, and the discharge pipe PBout are exposed to the outside.

As illustrated in FIG. 4 and FIG. 5, in the cover member 65, a circuit board 73 having the connector 75 is accommodated. The connector 75 on the circuit board 73 is exposed to the outside through a connection opening 63, which is a through hole, on the −Z side surface of the cover member 65. To the connector 75, a wire (not illustrated) is to be connected for connection to the external control unit 3.

The flow path member 60 has a planar shape similar to the ejection surface 10, as illustrated in FIG. 14. It is not necessary that the planner shape of the flow path member 60 be the same as the ejection surface 10 as long as the shape includes portions similar to the above-described first portion P1, second portion P2, and the third portion P3. This similarly applies to the planar shapes of the holder 30 and the cover member 65.

In plan view illustrating the ejection surface 10 in the flow path member 60, a portion overlapping the first portion P1 is referred to as a first flow path portion 21, a portion overlapping the second portion P2 is referred to as a second flow path portion 22, and a portion overlapping the third portion P3 is referred to as a third flow path portion 23.

The second flow path portion 22 has the supply pipe PAin and the supply pipe PBin. The third flow path portion 23 has the discharge pipe PAout and the discharge pipe PBout. The connector 75 overlaps the first flow path portion 21 in plan view from the Z direction.

The second flow path portion 22 and the third flow path portion 23 having the supply pipe PAin, the supply pipe PBin, the discharge pipe PAout, and the discharge pipe PBout prevent the flow path member 60 from being increased in size without providing spaces for the supply pipe PAin, the supply pipe PBin, the discharge pipe PAout, and the discharge pipe PBout outside the first flow path portion 21, the second flow path portion 22, and the third flow path portion 23 in the flow path member 60. Furthermore, the design of the second flow path portion 22 and the third flow path portion 23 having the supply pipe PAin, the supply pipe PBin, the discharge pipe PAout, and the discharge pipe PBout allows the connector 75 to be provided in the first flow path portion 21, enabling the compact flow path member 60 with the effective use of space.

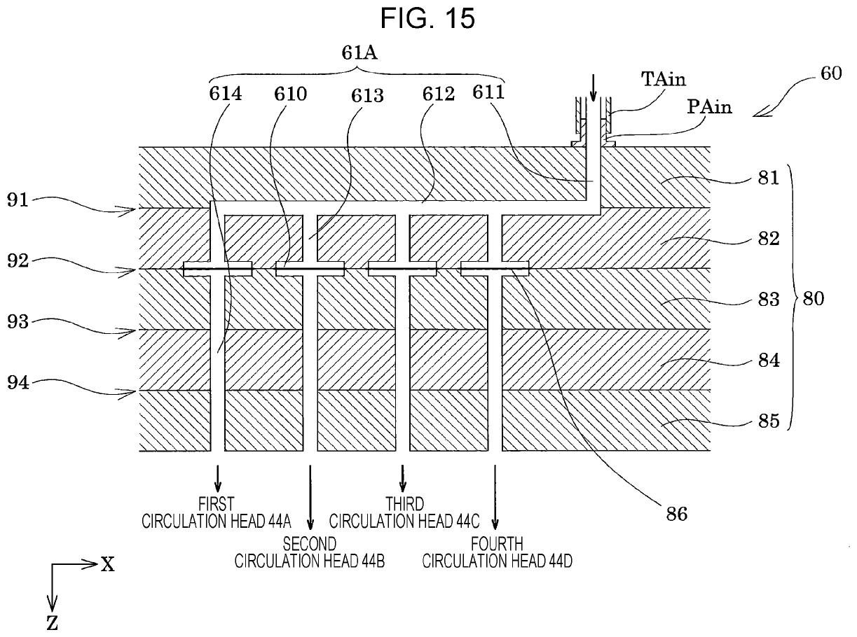

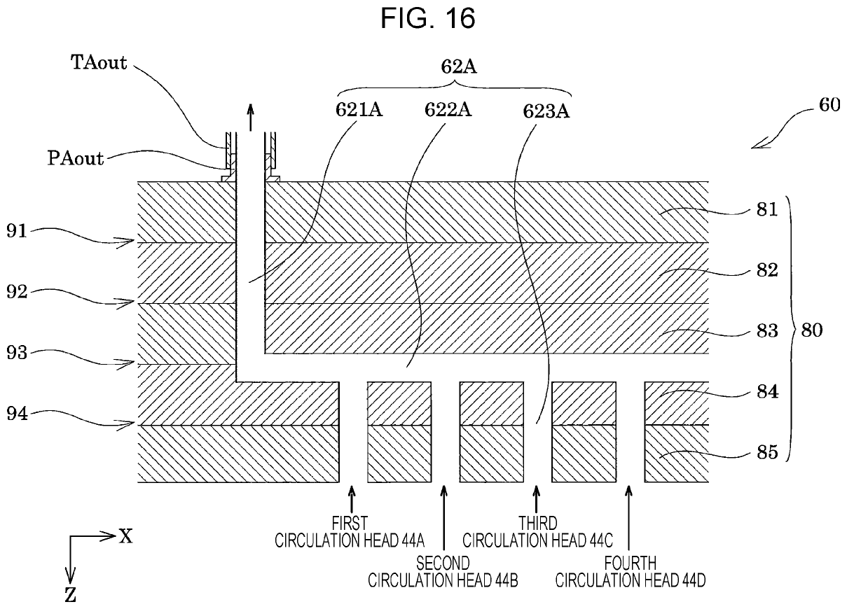

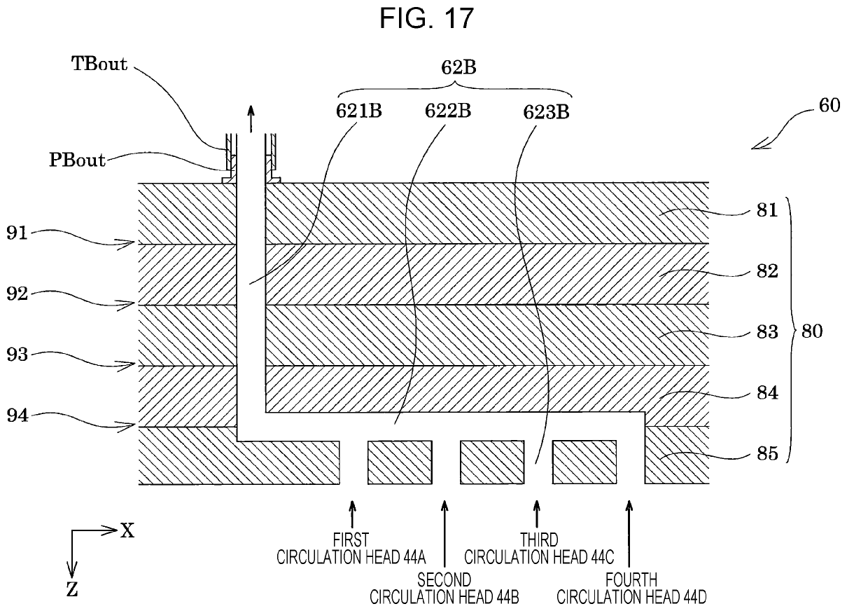

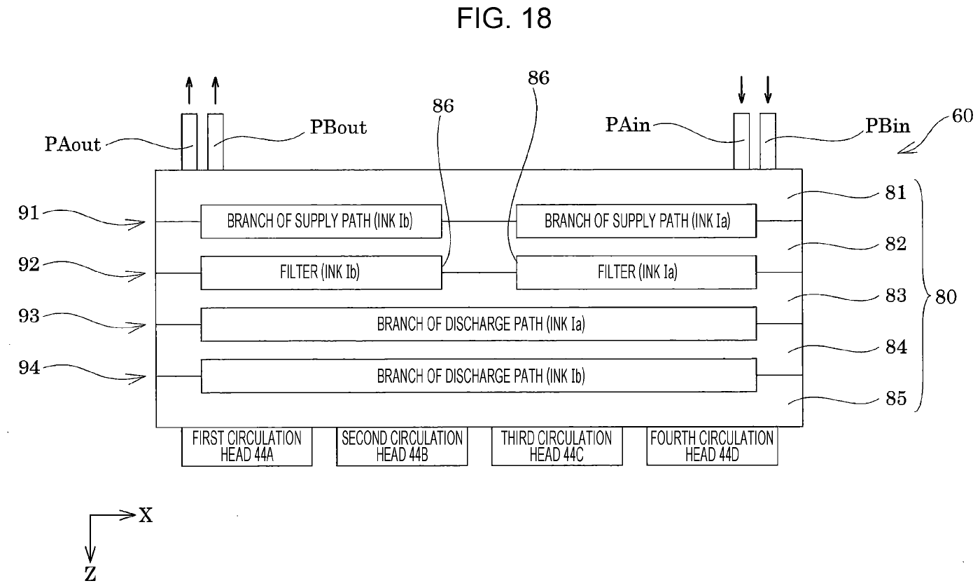

Hereinafter, the supply path 61A, the supply path 61B, the discharge path 62A, and the discharge path 62B in the flow path member 60 will be further described with reference to FIG. 15 to FIG. 18. FIG. 15 is a cross-sectional view illustrating flow paths in the flow path member. FIG. 16 and FIG. 17 are cross-sectional views illustrating the discharge paths in the flow path member. FIG. 18 is a schematic view illustrating a flow path structure of the flow path member.

As illustrated in the drawings, the flow path member 60 according to the embodiment includes a plurality of flow path plates 80 stacked in the Z direction, in this embodiment, five flow path plates 80. In this embodiment, the five flow path plates stacked in the Z direction are referred to as, in order from the −Z side toward the +Z side, a first flow path plate 81, a second flow path plate 82, a third flow path plate 83, a fourth flow path plate 84, and a fifth flow path plate 85.

In the flow path member 60, the supply path 61A and the supply path 61B, and the discharge path 62A and the discharge path 62B are provided. Into the flow path member 60, different types of ink are supplied by the supply path 61A and the supply path 61B, and the discharge path 62A and the discharge path 62B. In this embodiment, the two inks are referred to as an ink Ia and an Ink Ib respectively.

As illustrated in FIG. 15, from the upstream side toward the downstream side, the supply path 61A includes a first supply path 611, a second supply path 612, a third supply path 613, a filter chamber 610, and a fourth supply path 614.

The first supply path 611 is a through hole in the first flow path plate 81 in the Z direction and is open on the −Z side surface and the +Z side surface of the first flow path plate 81. An end portion of the first supply path 611 on the −Z side is connected to the supply pipe PAin.

The second supply path 612 is disposed along a first interface 91 between the first flow path plate 81 and the second flow path plate 82 joined with each other, and is a horizontal flow path extending in a direction orthogonal to the Z direction, that is, along an XY plane. An end portion of the second supply path 612 communicates with an end portion of the first supply path 611 on the +Z side. The second supply path 612 is formed by aligning openings of recesses provided on the first flow path plate 81 and the second flow path plate 82. In the second supply path 612, the recess may be provided only on the first flow path plate 81, or only on the second flow path plate 82.

The third supply path 613 is a through hole in the second flow path plate 82 in the Z direction. One end of the third supply path 613 communicates with the other end of the second supply path 612, and the other end is open on the +Z side surface of the second flow path plate 82. In this embodiment, four third supply paths 613 are provided. Specifically, the second supply path 612 is branched into four third supply paths 613 at the interface between the first flow path plate 81 and the second flow path plate 82.

The filter chamber 610 is disposed along a second interface 92 between the second flow path plate 82 and the third flow path plate 83 joined with each other. The filter chamber 610 is formed by aligning openings of recesses provided on the second flow path plate 82 and the third flow path plate 83. The filter chamber 610 communicates with the other end of the third supply path 613. In this embodiment, the filter chamber 610 is independently provided for each of the four third supply paths 613.

In the filter chambers 610, a filter 86 is provided across the supply path 61A. In this embodiment, the filter 86 is disposed along the second interface 92 between the second flow path plate 82 and the third flow path plate 83. Such a filter 86 catches bubbles and foreign matter such as dust in the ink to filter the ink. For example, the filter 86 may be a sheet-type filter having fine holes made of finely woven or knitted fibers of a metal, resin, or the like, or a plate-type filter of a metal, resin, or the like having fine through holes. The filter 86 may be made of a non-woven fabric of a metal, resin, or the like.

The filter 86 in the supply path 61A for supplying the ink to the circulation heads 44 removes bubbles and foreign matter such as dust in the ink, reducing the foreign matter contained in the ink to be supplied to the circulation heads, and thus the occurrence of ink droplet discharge failure can be reduced.

It is preferable that the filter chambers 610 having the filter 86 in the supply path 61A be provided in the first flow path portion 21 in the flow path member 60 illustrated in FIG. 14. As described above, the filter chambers 610 in the first flow path portion 21 having relatively large area in the flow path member 60 provide the space for the filter 86, and thus the filter 86 having relatively large area can be provided. With this structure, the pressure loss due to the filter 86 can be reduced and the occurrence of supply failure can be reduced. Similarly, the filter 86 in the supply path 61B is provided in the first flow path portion 21. The design of the filter chambers 610 provided in the first flow path portion 21 in the flow path member 60 enable the circulation heads 44 to have substantially the same flow path length between the filter chambers 610 and the circulation heads 44. The low variation in the flow path length of the parallel flow paths between the filter chambers 610 and the circulation heads 44 respectively provides substantially the same resistance, and the variation in the flow rate between the parallel flow paths can be reduced.

The fourth supply path 614 is a through hole that passes through the third flow path plate 83, the fourth flow path plate 84, and the fifth flow path plate 85 in the Z direction. One end of the fourth supply path 614 communicates with the filter chamber 610, and the other end is open on the +Z side surface of the fifth flow path plate 85. Four fourth supply paths 614 are provided for the corresponding four filter chambers 610.

The flow path member 60 includes the supply path 61B, and the structure of the supply path 61B is similar to that of the above-described supply path 61A, and thus the overlapping description will be omitted.

As illustrated in FIG. 16, from the downstream side toward the upstream side, the discharge path 62A includes a first discharge path 621A, a second discharge path 622A, a third discharge path 623A.

The first discharge path 621A is a through hole in the first flow path plate 81, the second flow channel plate 82, and the third flow channel plate 83 in the Z direction. One end of the first discharge path 621A is open on a −Z side surface of the first flow channel plate 81, and the other end is open on a +Z side surface of the third flow path plate 83.

The second discharge path 622A is disposed along a third interface 93 between the third flow path plate 83 and the fourth flow path plate 84 fixed to each other, and is a horizontal flow path extending in a direction orthogonal to the Z direction, that is, along an XY plane. An end portion of the second discharge path 622A communicates with an end portion of the first discharge path 621A on the +Z side. The second discharge path 622A is formed by aligning openings of recesses provided on the third flow path plate 83 and the fourth flow path plate 84. In the second discharge path 622A, the recess may be provided only on the third flow path plate 83, or only on the fourth flow path plate 84.

The third discharge path 623A is a through hole in the fourth flow path plate 84 and the fifth flow path plate 85 in the Z direction. One end of the third discharge path 623A communicates with the other end of the second discharge path 622A, and the other end is open on the +Z side surface of the fifth flow path plate 85. In this embodiment, four third discharge paths 623A are provided. Specifically, the second discharge path 622A is branched into four third discharge paths 623A at the third interface 93 between the third flow path plate 83 and the fourth flow path plate 84.

As illustrated in FIG. 17, from the downstream side toward the upstream side, the discharge path 62B includes a first discharge path 621B, a second discharge path 622B, a third discharge path 623B. Among the discharge paths, the second discharge path 622B is a horizontal flow path provided along a fourth interface 94 between the fourth flow path plate 84 and the fifth flow path plate 85 fixed to each other. Specifically, the second discharge path 622B is branched into four third discharge paths 623B at the interface between the fourth flow path plate 84 and the fifth flow path plate 85.

As illustrated in FIG. 18, in the flow path member 60, the interface at which the supply path 61A and the supply path 61B are branched is only one interface, that is, the first interface 91 between the first flow path plate 81 and the second flow path plate 82, whereas the interface at which the discharge path 62A and the discharge path 62B are branched is two interfaces, that is, the third interface 93 between the third flow path plate 83 and the fourth flow channel plate 84 and the fourth interface 94 between the fourth flow path plate 84 and the fifth flow path plate 85. Accordingly, the number of interfaces along which the discharge paths 62A and 62B are branched is larger than the number of interfaces along which the supply paths 61A and 61B are branched. With this structure, the space for providing the discharge paths 62A and 62B is larger than the space for providing the supply paths 61A and 61B, and thus the flow path cross-sectional areas of the discharge paths 62A and 62B is larger than the flow path cross-sectional areas of the supply paths 61A and 61B. Consequently, the larger flow path cross-sectional areas of the discharge paths 62A and 62B than the flow path cross-sectional areas of the supply paths 61A and 61B provide the lower flow path resistance in the discharge paths 62A and 62B than the flow path resistance in the supply paths 61A and 61B, and thus the pressure loss in the discharge paths 62A and 62B is lower than the pressure loss in the supply paths 61A and 61B. Accordingly, even if the total amount of ink discharged from the nozzles N varies, the pressure fluctuations in the manifold SR can be suppressed and the pressure in the manifold SR can be stabilized. For example, in one circulation head 44, in discharging ink from one nozzle N or from all nozzles N, the amounts of ink consumption differ from each other. When the flow path resistance in the discharge paths 62A and 62B is high, a difference in the amount of consumption of ink ejected simultaneously causes a difference in pressure in the manifolds SR. This is because the change in the flow rate of the ink flowing through the discharge paths 62A and 62B due to the difference in ink consumption amounts changes the dynamic pressure from the circulation heads 44 to the liquid containers 2A and 2B, causing pressure fluctuations in the circulation heads 44. Such a difference in pressure in the manifolds SR due to the ink consumption amount difference causes a difference in the weight of discharged ink, resulting in uneven ink application to a medium S. In particular, nozzles N that discharge ink droplets of the same color tend to generate uneven streaks of ink due to an ink weight difference. In this embodiment, the low flow path resistance in the discharge paths 62A and 62B reduces the occurrence of pressure fluctuations in the manifolds SR due to the difference in the discharged ink consumption, resulting in a small difference in weight of discharged ink regardless of the number of nozzles N simultaneously discharging ink droplets. As a result, the occurrence of uneven ink application to the medium S can be reduced.

In the head unit 1 having the above-described structure, the ink is supplied to the circulation heads 44 from the liquid container 2 through the flow path member 60, a print signal or the like is transmitted from the control unit 3 via the circuit board 73, or the like, and in accordance with the print signal, or the like, the piezoelectric actuators 484 in the circulation heads 44 are driven, and thereby ink droplets are ejected from the nozzles N.

As described above, the head unit 1 according to the embodiment includes, when the three directions orthogonal to each other are the X direction, the Y direction, and the Z direction, the circulation heads 44 disposed at the different positions on the XY plane defined by the X direction and the Y direction, the supply pipes PAin and PBin configured to supply an ink, which is an externally supplied liquid, to the circulation heads 44, the discharge pipes PAout and PBout configured to discharge the ink from the circulation heads 44 to the outside, and the flow path members 60 having the supply paths 61A and 61B and the discharge paths 62A and 62B connecting the circulation heads 44, the supply pipes PAin and PBin, and the discharge pipes PAout and PBout. In the head unit 1, each circulation head 44 includes the nozzle plate 487 having the nozzles N, and when the circulation head 44 is viewed from the Z direction in plan view, the nozzles N in the circulation head 44 includes the first nozzles Na on one end side in the X direction and the second nozzles Nb on the other end side in the X direction, and during circulation, the liquid pressure in the first nozzles Na is higher than the liquid pressure in the second nozzles Nb, and when the head unit 1 is viewed from the Z direction in plan view, the first nozzles Na are disposed on both ends in the X direction or the second nozzles Nb are disposed on both ends in the X direction.

With the structure of the head unit 1 having the first nozzles Na on both ends in the X direction or the second nozzles Nb on both ends in the X direction, when the head units 1 are disposed side by side in the X direction, the difference in weight of ink discharged from the adjacent nozzles N can be reduced between the head units 1 adjacent in the X direction. Accordingly, the density difference between the adjacent head units 1 in the X direction causes less color unevenness, and thus the print quality can be increased.

The head unit 1 according to the embodiment includes, when the three directions orthogonal to each other are the X direction, the Y direction, and the Z direction, the circulation heads 44 disposed at the different positions on the XY plane defined by the X direction and the Y direction, the supply pipes PAin and PBin configured to supply an ink, which is an externally supplied liquid, to the circulation heads 44, the discharge pipes PAout and PBout configured to discharge the ink from the circulation heads 44 to the outside, and the flow path members 60 having the supply paths 61A and 61B and the discharge paths 62A and 62B connecting the circulation heads 44, the supply pipes PAin and PBin, and the discharge pipes PAout and PBout. In the head unit 1, each circulation head 44 includes the nozzles N configured to eject the ink and a manifold SR with which the nozzles N commonly communicate. When the circulation heads 44 are viewed from the Z direction in plan view, each circulation head 44 has a supply port Rin configured to supply the ink to the manifold SR on one end side in the X direction and a discharge port Rout configured to discharge the ink in the manifold SR on the other end side in the X direction. When the head unit 1 is viewed from the Z direction in plan view, the supply ports Rin are disposed at both ends in the X direction or the discharge ports Rout are disposed at both ends in the X direction.

With the structure of the head unit 1 having the supply ports Rin on both ends in the X direction or the discharge ports Rout at both ends in the X direction, when the head units 1 are disposed side by side in the X direction, the difference in weight of ink discharged from the adjacent nozzles N between the head units 1 adjacent in the X direction can be reduced. Accordingly, the density difference between the adjacent head units 1 in the X direction causes less color unevenness, and thus the print quality can be increased.

In the head unit 1 according to the embodiment, when the head unit 1 is viewed from the Z direction in plan view, the second nozzles Nb may be disposed at both ends in the X direction. The supply ports Rin for supplying the ink to the manifold, with which the nozzles N commonly communicate, are disposed at the end portion on the first nozzle Na side in the X direction, and the discharge ports Rout for discharging the ink from the manifold SR are disposed at the end portion on the second nozzle Nb side in the X direction. With this structure, the second nozzles Nb disposed at both end portions in the X direction in the head unit 1 enable the supply ports Rin to be disposed in the area narrow in the x direction and enable the supply path for supplying the ink to the supply ports to be readily routed, and thus the increase in the path length can be prevented and the increase in the flow path resistance can be suppressed. Note that as illustrated in FIG. 10, the first nozzles Na may be disposed at both end portions of the head unit 1 in the X direction.

In the head unit 1 according to the embodiment, a planar shape of the XY plane of the ejection surface 10 having the nozzles N may have the first portion P1 through which the center line L parallel to the long side E1 of the rectangle R of the smallest area including the ejection surface 10 passes, the second portion P2 through which the center line L does not pass, the first portion P1 and the second portion P2 disposed along the direction of the long side E1, and the third portion P3 through which the center line L does not pass, the third portion P3 disposed on the opposite side of the second portion P2 across the first portion P1. In plan view from the Z direction, in the first flow path portion 21 in the flow path member 60 overlapping the first portion P1, the filter 86 configured to filter the ink, which is a liquid, may be provided. With this structure, the filter 86 is provided in the first flow path portion 21 having a relatively large area, and thus the filter 86 having the relatively large area can be provided. Accordingly, the pressure loss due to the filter 86 can be suppressed and the occurrence of supply failure can be reduced. Furthermore, as compared with a structure in which the filter 86 is disposed such that a surface direction corresponds to the Z direction orthogonal to the XY plane, which is the nozzle surface, the flow path member 60 is not increased in size in the Z direction. Furthermore, as compared with the structure in which the filter 86 is disposed such that a surface direction corresponds to the Z direction orthogonal to the XY plane, which is the nozzle surface, the flow path member 60 is not increased in size in the Z direction. Note that the filter 86 may be disposed in a portion other than the first flow path portion 21, for example, in the second flow path portion 22 or the third flow path portion 23, or across the first flow path portion 21, the second flow path portion 22, and the third flow path portion 23.

In the head unit 1 according to the embodiment, the flow path resistance from the discharge pipes PAout and PBout to the circulation head 44 may be smaller than the flow path resistance from the supply pipes PAin and PBin to the circulation head 44. The flow path resistance in the discharge paths from the discharge tubes to the circulation head lower than the flow path resistance in the supply paths from the supply tubes to the circulation head reduces the occurrence of pressure fluctuations in the manifolds, which commonly communicate with the nozzles, due to a difference in the consumption of the ink simultaneously discharged from the nozzles. Accordingly, the difference in weight of the ink discharged from the nozzles can be suppressed. As a result, the occurrence of uneven ink application to the medium can be reduced. Note that, the flow path resistance from the discharge pipes PAout and PBout to the circulation head 44 may be lower than the flow path resistance from the supply pipes PAin and PBin to the circulation head 44.

In the head unit 1 according to the embodiment, the flow path member 60 may include the stacked flow path plates 80. The supply paths 61A and 61B connecting the circulation heads 44, the supply pipes PAin and PBin, and the discharge pipes PAout and PBout may include the second supply path 612 and the second discharge paths 622A and 622B, which are the horizontal flow paths formed along the first interface 91, the third interface 93, and the fourth interface 94 respectively in the stacked flow path plates 80. The second supply path 612 and the second discharge paths 622A and 622B may be branched along at least one of the interfaces, and the number of the interfaces along which the second discharge paths 622A and 622B connecting the circulation heads 44 and the discharge pipes PAout and PBout are branched may be greater than or equal to the number of the interfaces along which the second supply path 612 connecting the circulation heads 44 and the supply pipes PAin and PBin is branched. With this structure, the number of the interfaces along which the second discharge paths 622A and 622B, which are the horizontal flow paths that serve as the discharge paths 62A and 62B, are branched is greater than or equal to the number of the interfaces along which the second supply path 612, which is the horizontal flow path that serves as the supply paths 61A and 61B, is branched, and thus the space for providing the discharge paths 62A and 62B is larger than the space for providing the supply paths 61A and 61B. Accordingly, the flow path cross-sectional areas of the discharge paths 62A and 62B are larger than the flow path cross-sectional areas of the supply paths 61A and 61B. With this structure, the flow path resistance in the discharge paths 62A and 62B is lower than the flow path resistance in the supply paths 61A and 61B. Note that when the number of the interfaces along which the second discharge paths 622A and 622B connecting the circulation heads 44 and the discharge pipes PAout and PBout are branched is equal to the number of the interfaces along which the second supply path 612 connecting the circulation heads 44 and the supply pipes PAin and PBin is branched, the supply paths 61A and 62B need the space for the filter chambers 610, and thus the space for providing the discharge paths 62A and 62B is wider than the space for providing the supply paths 61A and 61B.

In this embodiment, the second supply path 612 is branched along the second interface 92, and the number of the interfaces is one, whereas the second discharge paths 622A and 622B are branched along the third interface 93 and the fourth interface 94 respectively, and the number of the interfaces is two. Accordingly, the number of the interfaces along which the second discharge paths 622A and 622B connecting the circulation heads 44 and the discharge pipes PAout and PBout are branched may be larger than the number of the interfaces along which the second supply path 612 connecting the circulation heads 44 and the supply pipes PAin and PBin is branched. With this structure, the space for providing the discharge paths 62A and 62B can be further increased, and thus the flow path cross-sectional areas of the discharge paths 62A and 62B can be further increased.

In the head unit 1 according to the embodiment, the supply tubes TAin and TBin, and the discharge tubes TAout and TBout, which are tubes, may be connected to the supply pipes PAin and PBin and the discharge pipes PAout and PBout respectively. With this structure, the tubes connected to the supply pipes PAin and PBin and the discharge pipes PAout and PBout provide easy routing and connection of the tubes, and when a trouble such as a failure occurs in the head unit 1, only the head unit 1 in which the trouble has occurred can be readily replaced without replacing the entire head module 100.

The head unit 1 may further include the connector 75 to which an external wire is to be connected. With the connector 75 in the head unit 1, the external wiring can be readily routed and connected, and when a trouble such as a failure occurs in the head unit 1, only the head unit 1 in which the trouble has occurred can be readily replaced without replacing the entire head module 100.

The head unit 1 may further include the fixing holes 104 fixed by the screws 103 to the supporting member 101 that supports the head unit 1. With the structure in which the head unit 1 is fixed to the supporting member 101 with the screws 103, the head unit 1 and the supporting member 101 can be readily assembled, and when a trouble such as a failure occurs, only the head unit 1 in which the trouble has occurred can be readily replaced without replacing the entire head module 100.

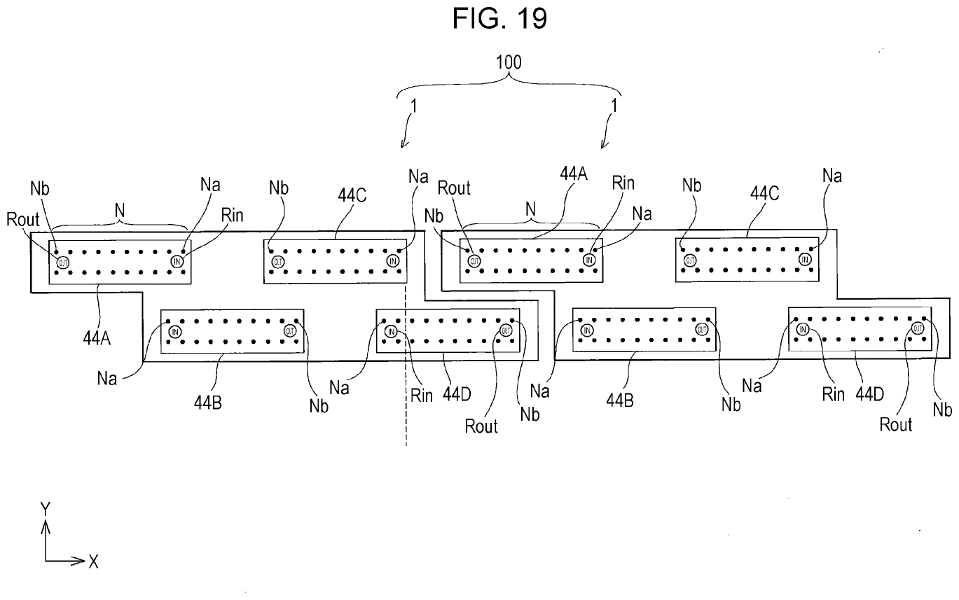

In this embodiment, for one circulation head, two supply ports and two discharge ports are provided; however, the structure is not particularly limited to this example. FIG. 19 illustrates a modification of the head unit. As illustrated in FIG. 19, each circulation head 44 has one supply port Rin and one discharge port Rout. Accordingly, in the head units 1, the circulation heads 44 are disposed such that the discharge ports Rout are at both end portions in the X direction. Similarly to the head unit illustrated in FIG. 10, in the head units 1, the circulation heads 44 may also be disposed such that the supply ports Rin are at both end portions in the X direction.

### Second Embodiment

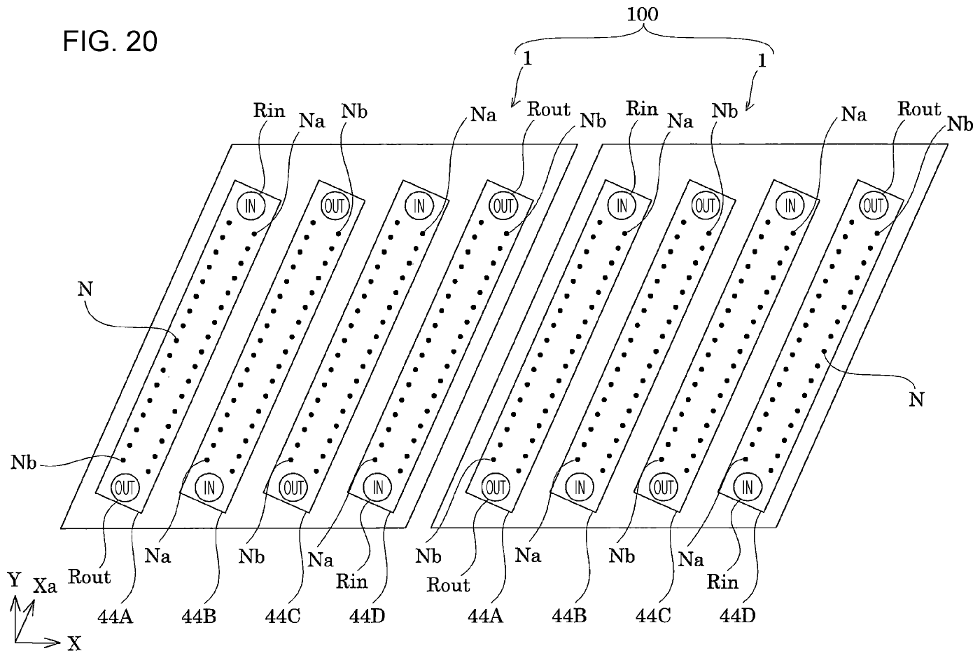

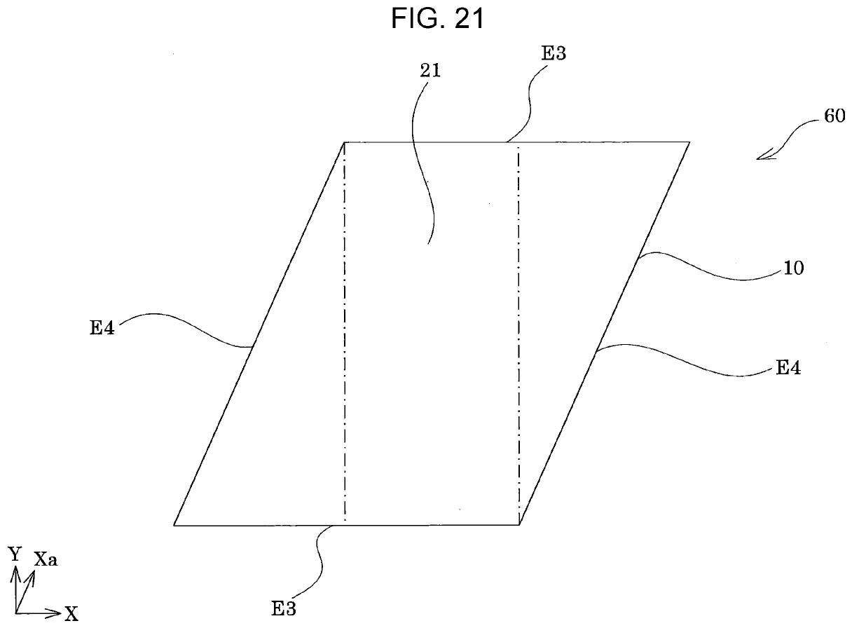

FIG. 20 is a plan view illustrating circulation heads in a head module according to a second embodiment of the present disclosure viewed from the −Z side. FIG. 21 is a plan view of a flow path member viewed from the −Z side. To components similar to those in the above-described embodiments, same reference numerals are given, and their descriptions will be omitted.

As illustrated in FIG. 20, the head unit 1 includes a plurality of the circulation heads 44, in this embodiment, includes four circulation heads 44.

The circulation heads 44 are disposed such that the nozzles N are arranged in an Xa direction that is inclined with respect to the X direction, which is the transport direction of the medium S, and the Y direction, which is the transport direction of the transport member 7. In this arrangement, each circulation head 44 has the first nozzle Na and the supply port Rin on one end side in the X direction, and the second nozzle Nb and the discharge port Rout on the other end side in the X direction. The circulation heads 44 are disposed side by side in the X direction. In this embodiment, the circulation heads 44 are disposed such that the positions in the Y direction are the same, that is, the circulation heads 44 overlap in the X direction.

With this structure, the arrangement direction Xa of the nozzles N is inclined with respect to the X direction and the Y direction, and the circulation heads 44 are disposed side by side in the X direction and thus at least part of the nozzles N of the circulation heads 44 adjacent in the X direction can be disposed at positions overlapping in the Y direction.

Furthermore, in plan view viewed from the Z direction, the outer shape of the both sides in the Y direction of the ejection surface 10 of the head unit 1 is an outer shape along the direction Xa. Specifically, the side surfaces on both sides in the Y direction of the ejection surface 10 of the head unit 1 in the +Z side are inclined in the same direction as the Xa direction, which is the arrangement direction of the nozzles N. With this structure, when the head units 1 are disposed side by side in the Y direction, at least part of the nozzles N of the two head units 1 adjacent in the Y direction can be disposed at positions overlapping in the X direction. Accordingly, the nozzles N disposed side by side at substantially the same intervals in the Y direction can be provided in the head module 100.

The head units have the circulation heads 44 having the second nozzles Nb at both end portions in the X direction or the first nozzles Na at both end portions in the X direction. In this embodiment, the circulation heads 44 are disposed such that the second nozzles Nb are disposed at both end portions in the X direction in the head unit 1. Specifically, in order from the −X side toward the +X direction, if the circulation heads 44 disposed side by side in the X direction are referred to as a first circulation head 44A, a second circulation head 44B, a third circulation head 44C, and a fourth circulation head 44D, on the −X side of the first circulation head 44A, the second nozzle Nb is disposed, and on the +X side of the fourth circulation head 44D, the second nozzle Nb is disposed. The both end portions are portions where, among all nozzles N in the circulation heads 44, the nozzle N at the end portion in the −X direction and the nozzle N at the end portion in the +X direction are disposed, and the circulation heads 44 are disposed such that the nozzles N at the both end portions are the second nozzles Nb.

Accordingly, with the structure in which the nozzles N on both ends in the X direction in the head unit 1 are the second nozzles Nb, in the head module 100 including the head units 1 arranged in the X direction, between the two head units 1 adjacent in the X direction, differences in pressure in the adjacent nozzles N are reduced and differences in weight of the ink discharged from the adjacent nozzles N can be suppressed. Accordingly, rapid change in the density of ink discharged from the nozzles N between two adjacent head units can be suppressed and the occurrence of the uneven ink application, in particular, uneven streaks of ink due to the density change can be reduced.

In this embodiment, two circulation heads 44 adjacent in the X direction, that is, two circulation heads 44 disposed so as to overlap in the Y direction are arranged such that nozzle N of one circulation head 44 at the end portion on the side close to the other circulation head 44 is the nozzle N of the same type as the nozzle N of the other circulation head 44 at the end portion on the side close to the one circulation head 44. In this embodiment, in the first circulation head 44A and the second circulation head 44B adjacent in the X direction, the nozzle N of the first circulation head 44A at the end portion on the +X side is the first nozzle Na, and the nozzle N of the second circulation head 44B at the end portion on the −X side is the first nozzle Na.

Similarly, in the second circulation head 44B and the third circulation head 44C adjacent in the X direction, the nozzle N of the second circulation head 44B at the end portion on the +X side is the second nozzle Nb, and the nozzle N of the third circulation head 44C at the end portion on the −X side is the second nozzle Nb.

Similarly, in the third circulation head 44C and the fourth circulation head 44D adjacent in the X direction, the nozzle N of the third circulation head 44C at the end portion on the +X side is the first nozzle Na, and the nozzle N of the fourth circulation head 44D at the end portion on the −X side is the first nozzle Na.

With this structure, in the circulation heads 44 adjacent in the X direction, the nozzles N of the same type are disposed at the end portions in the overlapping parts in the Y direction, and thus the difference in pressure in the adjacent nozzles N in the circulation can be suppressed in the two circulation heads 44 adjacent in the X direction. Accordingly, between the two head units 44 adjacent in the X direction, the difference in weight of the ink discharged from the adjacent nozzles N can be suppressed. Consequently, rapid change in the density of ink discharged from the nozzles N between the two adjacent circulation heads 44 can be suppressed and the occurrence of the uneven ink application, in particular, uneven streaks of ink due to the density change can be reduced.

As illustrated in FIG. 21, the flow path member 60 has substantially the same shape as the ejection surface 10 of the head unit 1. Specifically, a planar shape of the XY plane of the flow path member 60 has an outside shape of a parallelogram having two first sides E3 parallel in the X direction and two second sides E4 parallel in the Xa direction inclined with respect to the Y direction and the X direction.

The flow path member 60 includes the first flow path portion 21 in which the first sides E3 overlap each other in the Y direction on the XY plane, and in the first flow path portion 21, includes a filter 86 similar to that according to the above-described first embodiment. As described above, the filter 86 is provided in the first flow path portion 21 having a relatively large area in the flow path member 60, and thus the filter 86 a having relatively large area can be provided. With this structure, the pressure loss due to the filter 86 can be suppressed and the occurrence of supply failure can be reduced. Furthermore, as compared with a structure in which the filter 86 is disposed such that a surface direction corresponds to the Z direction orthogonal to the XY plane, which is the nozzle surface, the flow path member 60 is not increased in size in the Z direction.

### Other Embodiments

As described above, the embodiments of the present disclosure have been described. However, the basic structures of the present disclosure are not limited to the above-described embodiments.

For example, in the above-described embodiments, each head unit 1 includes one or two sets of one supply pipe and one discharge pipe. Alternatively, each head unit 1 may include three or more sets of one supply pipe and one discharge pipe. The number of the supply pipes and the number of the discharge pipes are not limited to the same number, and may be different numbers.

In the above-described embodiments, the flow path member 60 has five flow path plates 80 stacked in the Z direction; however, the number of the flow path plates is not limited to this example, and the number of the flow path plates 80 may be one, or two or more. The direction of stacking the flow path plates 80 is not limited to the Z direction, and may be a direction intersecting the Z direction.

In the above-described embodiments, the circulation head 44 has the manifold SR through which the ink circulates; however, the circulation head 44 is not particularly limited to this, and the circulation head 44 may have a pressure chamber SC through which an ink circulates.

According to the above-described embodiments, in the liquid ejecting apparatus I, the head module 100 is supported by the transport member 7 and moved in the Y direction, which is the main scanning direction. However, the liquid ejecting apparatus I is not particularly limited to this, for example, the present disclosure may be applied to a liquid ejecting apparatus that has a fixed head module 100 and performs printing only by moving a medium S such as paper in the sub-scanning direction, that is, a so-called line liquid ejecting apparatus.

In the above-described embodiments, the head unit 1 for ejecting an ink and the ink jet recording apparatus, which is an example liquid ejecting apparatus I, have been described. However, the present disclosure may be widely used for head units and general liquid ejecting apparatus, and may be applied to head units and liquid ejecting apparatuses for ejecting liquid other than ink. For example, some embodiments of the head unit may be applied to various head units to be used for image recording apparatuses such as printers, color material ejecting head units to be used to manufacture color filters for liquid crystal displays or the like, electrode material ejecting head units to be used to form electrodes for organic electro luminescence (EL) displays, field emission displays (FEDs), or the like, or bioorganic matter ejecting head units to be used to manufacture biochips (biochemical elements), or may be applicable to liquid ejecting apparatuses having any of these heads.

What is claimed is:

1. A head unit comprising:
when three directions orthogonal to each other are an X direction, a Y direction, and a Z direction, a plurality of circulation heads disposed at different positions on an XY plane defined by the X direction and the Y direction;
supply pipes configured to supply externally supplied liquid to the circulation heads;
discharge pipes configured to discharge the liquid from the circulation heads to the outside; and
flow path members having flow paths connecting the circulation heads, the supply pipes, and the discharge pipes, wherein
each circulation head includes a nozzle plate having a plurality of nozzles,
when the circulation head is viewed from the Z direction in plan view, the nozzles in the circulation head include first nozzles on one end side in the X direction and second nozzles on the other end side in the X direction, and during circulation, the liquid pressure in the first nozzles is higher than the liquid pressure in the second nozzles, and
when the head unit is viewed from the Z direction in plan view, the first nozzles are disposed on both ends in the X direction or the second nozzles are disposed on both ends in the X direction.

2. A head unit comprising:
when three directions orthogonal to each other are an X direction, a Y direction, and a Z direction, a plurality of circulation heads disposed at different positions on an XY plane defined by the X direction and the Y direction;
supply pipes configured to supply externally supplied liquid to the circulation heads;
discharge pipes configured to discharge the liquid from the circulation heads to the outside; and
flow path members having flow paths connecting the circulation heads, the supply pipes, and the discharge pipes, wherein
each circulation head has a plurality of nozzles configured to eject the liquid and a manifold with which the nozzles commonly communicate,
when the circulation heads are viewed from the Z direction in plan view, each circulation head has a supply port configured to supply the liquid to the manifold on one end side in the X direction and a discharge port configured to discharge the liquid in the manifold on the other end side in the X direction, and
when the head unit is viewed from the Z direction in plan view, the supply ports are disposed at both ends in the X direction or the discharge ports are disposed at both ends in the X direction.

3. The head unit according to claim 1, wherein when the head unit is viewed from the Z direction in plan view, the second nozzles are disposed at both ends in the X direction.

4. The head unit according to claim 1, wherein a planar shape of the XY plane of the ejection surface having the nozzles has a first portion through which a center line parallel to a long side of a rectangle of a smallest area including the ejection surface passes, a second portion through which the center line does not pass, the first portion and the second portion disposed along the direction of the long side, and a third portion through which the center line does not pass, the third portion disposed on the opposite side of the second portion across the first portion, and
in plan view from the Z direction, in a portion in the flow path member overlapping the first portion, a filter configured to filter the liquid is provided.

5. The head unit according to claim 1, wherein a planar shape of the XY plane of the ejection surface having the nozzles has an outside shape of a parallelogram having two first sides parallel in the X direction and two second sides parallel in a direction inclined with respect to the Y direction and the X direction,
the ejection surface has a first portion in which the first sides overlap each other on the XY plane in the Y direction, and
in plan view from the Z direction, in a portion in the flow path member overlapping the first portion, a filter configured to filter the liquid is provided.

6. The head unit according to claim 1, wherein a flow path resistance from the discharge pipe to the circulation heads is lower than a flow path resistance from the supply pipe to the circulation heads.

7. The head unit according to claim 6, wherein the flow path member includes stacked flow path plates,
the flow paths connecting the circulation heads, the supply pipes, and the discharge pipes include horizontal flow paths along interfaces between the stacked flow channel plates,
the horizontal flow paths are branched along at least one of the interfaces, and
the number of the interfaces along which the horizontal flow paths connecting the circulation heads and the discharge pipes are branched is greater than or equal to the number of the interfaces along which the horizontal paths connecting the circulation heads and the supply pipes are branched.

8. The head unit according to claim 1, wherein a tube is connected to each of the supply pipes and the discharge pipes.

9. The head unit according to claim 1, further comprising a connector to which an external wire is to be connected.

10. The head unit according to claim 1, further comprising a fixing hole fixed by a screw to a supporting member that supports the head unit.

11. A liquid ejecting apparatus comprising the head units according to claim 1.
